(19) United States
(12) Patent Application Publication
(10) Pub. No.: US 2026/0107199 A1
(43) Pub. Date: Apr. 16, 2026

(54) METHOD FOR CONFIGURING MEASUREMENT WINDOW, TERMINAL, AND NETWORK DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN)

(21) Appl. No.: 19/332,166

(22) Filed: Sep. 18, 2025

Related U.S. Application Data
(63) Continuation of application No. PCT/CN2023/084885, filed on Mar. 29, 2023.

(51) Int. Cl. H04W 36/00

(52) U.S. Cl. CPC H04W 36/0085; H04W 36/0058

(57) ABSTRACT

Provided is a method for configuring a measurement window. The method is performed by a terminal, and includes: receiving first configuration information, wherein the first configuration information is used to determine a measurement window configuration, wherein the measurement window configuration is used to monitor Layer 1 or Layer 2 triggered mobility (LTM) candidate cells.

### CROSS-REFERENCE TO RELATED APPLICATION

This application is a continuation application of international application No. PCT/CN2023/084885, filed on Mar. 29, 2023, the entire contents of which are incorporated herein by reference.

### TECHNICAL FIELD

The present disclosure relates to the technical field of wireless communications, and in particular, relates to a method for configuring a measurement window, a terminal, and a network device.

### RELATED ART

For communication quality between a user equipment (UE) and a network, the UE needs to monitor a channel quality of a serving cell (for example, a first cell) and a candidate cell (for example, a second cell), and switches the serving cell to the second cell in a case where the channel quality of the first cell is poor and the channel quality of the second cell is great.

### SUMMARY

Embodiments of the present disclosure provide a method for configuring a measurement window, a terminal, and a network device. The technical solutions are as follows.

According to some embodiments of the present disclosure, a method for configuring a measurement window. The method is performed by a terminal, and includes: receiving first configuration information, wherein the first configuration information is used to determine a measurement window configuration, wherein the measurement window configuration is used to monitor L1 or L2 triggered mobility (LTM) candidate cells.

According to some embodiments of the present disclosure, a terminal is provided. The terminal includes: a processor and a memory storing one or more instructions, one or more programs, a code set, or an instruction set; wherein the processor is configured to load and run the one or more instructions, the one or more programs, the code set, or the instruction set to cause the terminal to perform the method for configuring the measurement window.

According to some embodiments of the present disclosure, a network device is provided. The network device includes: a processor and a memory storing one or more instructions, the one or more programs, the code set, or the instruction set; wherein the processor is configured to load and run the one or more instructions, one or more programs, a code set, or an instruction set to cause the network device to perform the method for configuring the measurement window.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic diagram of a network architecture according to some embodiments of the present disclosure;

FIG. 2 is a schematic diagram of a network architecture according to some embodiments of the present disclosure;

FIG. 3 is a schematic diagram of a network architecture according to some embodiments of the present disclosure;

FIG. 4 is a schematic diagram of a network architecture according to some embodiments of the present disclosure;

FIG. 5 is a schematic diagram of a network architecture according to some embodiments of the present disclosure;

FIG. 6 is a schematic diagram of beam sweep according to some embodiments of the present disclosure;

FIG. 7 is a schematic diagram of a synchronization signal block according to some embodiments of the present disclosure;

FIG. 8 is a schematic diagram of a synchronization signal burst set according to some embodiments of the present disclosure;

FIG. 9 is a schematic diagram of a synchronization signal/physical broadcast channel block measurement timing configuration (SMTC) according to some embodiments of the present disclosure;

FIG. 10 is a schematic diagram of a bitmap according to some embodiments of the present disclosure;

FIG. 11 is a schematic diagram of a measurement gap (MG) according to some embodiments of the present disclosure;

FIG. 12 is a schematic diagram of a communication system according to some embodiments of the present disclosure;

FIG. 13 is a flowchart of a method for configuring a measurement window according to some embodiments of the present disclosure;

FIG. 14 is a flowchart of a method for configuring a measurement window according to some embodiments of the present disclosure;

FIG. 15 a flowchart of a method for configuring a measurement window according to some embodiments of the present disclosure;

FIG. 16 a flowchart of a method for configuring a measurement window according to some embodiments of the present disclosure;

FIG. 17 a schematic diagram of a configuration according to some embodiments of the present disclosure;

FIG. 18 a schematic diagram of a configuration according to some embodiments of the present disclosure;

FIG. 19 a schematic diagram of a configuration according to some embodiments of the present disclosure;

FIG. 20 a schematic diagram of a configuration according to some embodiments of the present disclosure;

FIG. 21 is a block diagram of an apparatus for configuring a measurement window according to some embodiments of the present disclosure;

FIG. 22 is a block diagram of an apparatus for configuring a measurement window according to some embodiments of the present disclosure; and

FIG. 23 is a schematic structural diagram of a communication device according to some embodiments of the present disclosure.

### DETAILED DESCRIPTION

For clearer descriptions of the objects, technical solutions, and advantages of the present disclosure, the embodiments of the present disclosure are described in detail hereinafter in combination with the accompanying drawings.

The network architecture and service scenarios described in the embodiments of the present disclosure are intended to illustrate the technical solutions according to the embodiments of the present disclosure more clearly instead of any limitations. Those skilled in the art understand that with evolution of the network architecture and emergence of new service scenarios, the technical solutions according to the embodiments of the present disclosure are also applicable to addressing similar technical problems.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, the term “predefined” refers to “defined” in a protocol.

The terms in the present disclosure are first described. 1. LTM

The switch process in some practices is triggered by L3 signaling (for example, radio resource control (RRC) reconfiguration (RRCReconfiguration)), and the switch process based on an L1/L2 measurement/signaling is introduced to further reduce the latency in the L3 switch. The cell switch process based on the L1/L2 measurement/signaling mainly includes the following three steps.

In S1, reception of a candidate cell configuration, that is, a UE receives a plurality of pieces of candidate cell configuration information from a network.

In S2, measurement and report of a measurement result, that is, the UE performs L1 measurement on all or part of candidate cells to acquire the measurement result at a beam/cell level, and the UE reports the measurement result to a current serving cell based on the configuration.

In S3, the UE receives L1/L2 signaling from the network and switches to a target cell. The L1/L2 signaling selects a target cell from a plurality of candidate cells. Furthermore, the L1/L2 signaling may also indicate or activate a transmission configuration indicator (TCI) state for the target cell to provide beam information for operation of the UE in the target cell. 2. SMTC

With pursuit of speed, latency, high mobility, and energy efficiency and diversity and complexity of services in future life, the 3^{rd} Generation Partnership Project (3GPP) international standard organization starts to develop 5^{th} generation mobile communication technology (5G). The application scenarios of the 5G mainly includes the enhanced mobile broadband (eMBB), the ultra-reliable low-latency communications (URLLC), and the massive machine type communication (mMTC).

The eMBB still aims to provide multimedia content, services, and data to the user, with rapidly increased requirements. In addition, as the eMBB may be deployed in different scenarios, for example, indoors, urban areas, and rural areas, and differences in capabilities and requirements are also significant. Therefore, the different scenarios cannot be generalized, and should be analyzed in detail based on specific deployment scenarios. Typical applications of the URLLC include industrial automation, power automation, remote medical operations (surgery), traffic safety assurance, and the like. Typical features of the mMTC include a high connection density, a small data volume, latency-insensitive services, low-cost and long service life of modules, and the like.

In the early stages of new radio (NR) deployment, achieving comprehensive NR coverage is difficult. Therefore, a typical network deployment consists of wide-area long-term evolution (LTE) coverage combined with island-like coverage of NR. Moreover, the widespread development of LET in frequency bands below 6 GHz leaves very limited spectrum available for new 5G services in the same bands. Consequently, NR development needs to explore the use of spectrum above 6 GHz; however, high-frequency bands offer limited coverage and suffer from significant signal attenuation. At the same time, to protect the prior investments of mobile operators in LTE, a “tight interworking” operational mode between LTE and NR has been proposed.

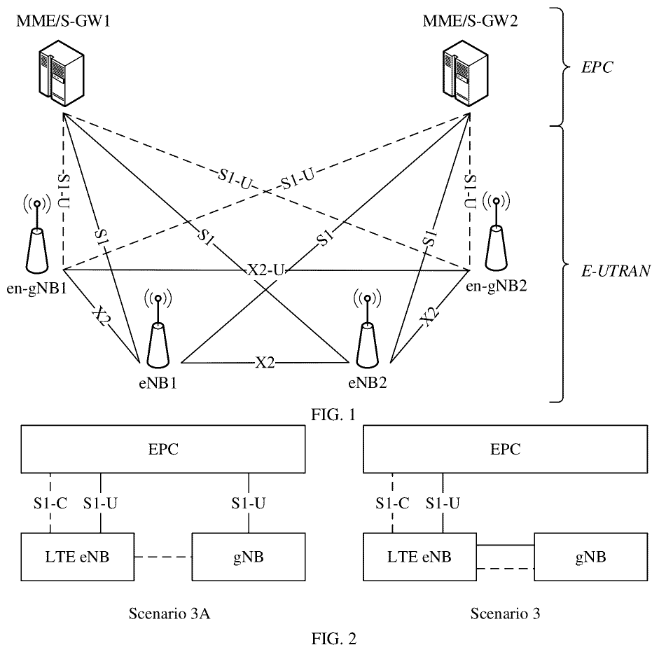

For deployment and commercialization of the 5G network as soon as possible, a first 5G version is completed in the 3GPP, that is, LTE-NR dual connectivity (EN-DC). The LTE serves as a master node (MN), the 5G serves as a secondary node (SN), and the network deployment and networking architecture are illustrated in FIG. 1. en-gNB 1 is connected to mobility management entity (MME)/serving gateway (S-GW)1 and MME/S-GW2 via an S1-U interface; en-gNB 2 is connected to MME/S-GW 1 and MME/S-GW 2 via the S1-U interface; en-gNB1 is connected to en-gNB 2 via a X2-U interface; eNB 1 is connected to MME/S-GW 1 and MME/S-GW 2 via an S1 interface; eNB 2 is connected to MME/S-GW 1 and MME/S-GW 2 via the S1 interface; and eNB 1 is connected to eNB 2 via an X2 interface. MME/S-GW 1 and MME/S-GW 2 belong to an evolved packet core (EPC, a 4G core network (CN)), and en-gNB 1, en-gNB 2, eNB 1, and eNB 2 belong to evolved UMTS terrestrial radio access (E-UTRAN). As illustrated in FIG. 2, in scenario 3A of EN-DC, the LTE eNB and the gNB are connected to the EPC; and in scenario 3 of EN-DC, the LTE eNB is connected to the EPC, and the gNB is connected to the EPC via the LTE eNB.

The MN mainly provides a main RRC control function and a control plane connected to the CN. The SN configures auxiliary signaling, for example signaling radio bearer 3 (SRB3), to mainly provide a data transmission function.

The later R15 supports other dual connectivity (DC) modes, for example, NR-LTE dual connectivity (NE-DC), 5^{th} generation core NR-LTE dual connectivity (5GC-EN-DC), and new radio-dual connectivity (NR-DC). For the EN-DC, the core network connected to the access network is the EPC, and the core network connected to other DC modes is a 5^{th} generation core (5GC, that is, a 5G core network).

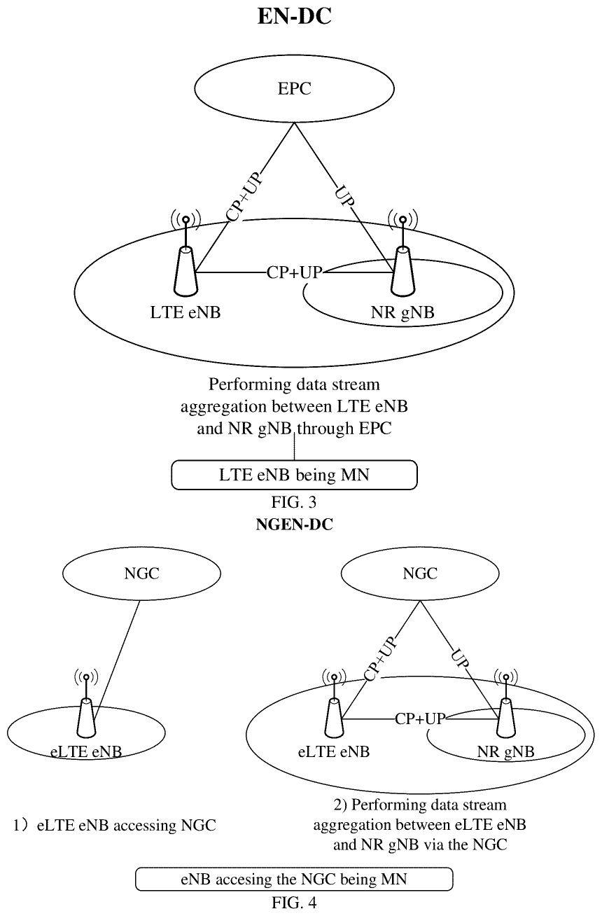

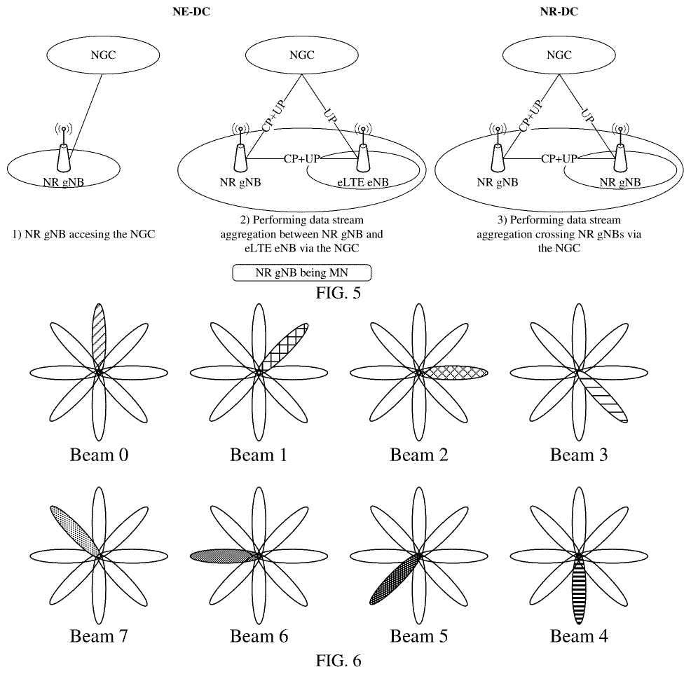

For example, as illustrated in FIG. 3, in the EN-DC scenario, the LTE eNB and the NR gNB are connected to the EPC. As illustrated in FIG. 4, in the next generation EN-DC (NGEN-DC) scenario, the LTE eNB and the NR gNB are connected to a next generation core (NGC, that is, a next generation core network), for example, the 5GC. As illustrated in FIG. 5, in the NE-DC scenario, the NR gNB and the eLTE eNB are connected to the NGC, for example, the 5GC; and in the NR-DC scenario, the two NR gNBs are connected to the NGC, for example, the 5GC.

The NR may also be deployed independently. The NR is deployed at the high frequency bands to improve the coverage. In the 5G, the requirement for the coverage is satisfied by introducing the beam sweeping mechanism (sacrificing space for coverage, sacrificing time for space).

After introducing the beam sweeping, synchronization signals need to be transmitted in each beam direction. For example, as illustrated in FIG. 6, synchronization signals are transmitted in eight beam directions (beam 0, beam 1, beam 2, beam 3, beam 4, beam 5, beam 6, beam 7) respectively.

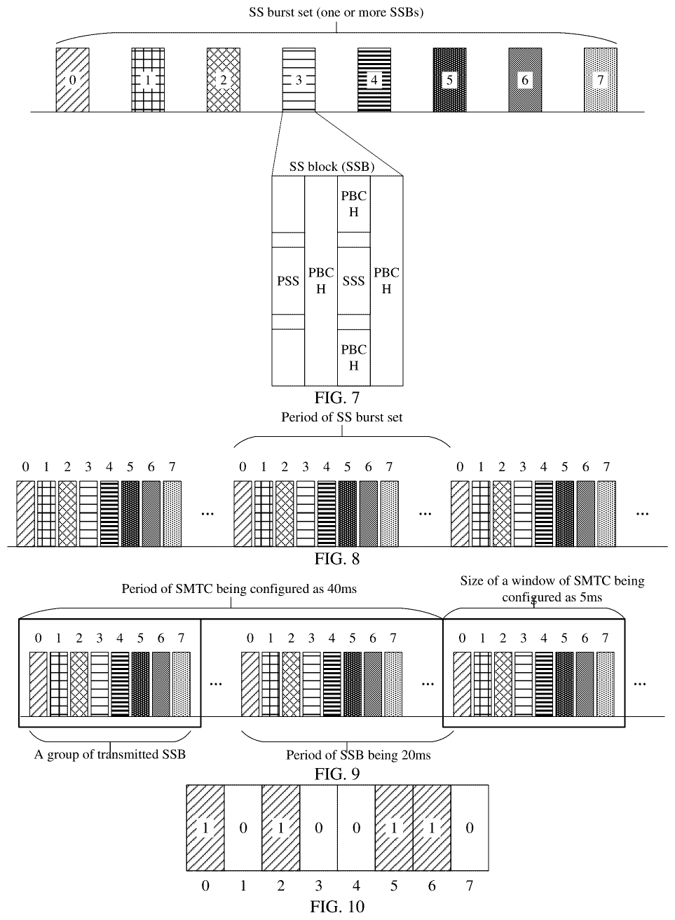

5G synchronization signals are transmitted in the form of a synchronization signal block (SSB: SS/physical broadcast channel (PBCH) block). As illustrated in FIG. 7, the SSB contains a primary synchronization signal (PSS), a secondary synchronization signal (SSS), and a PBCH. As illustrated in FIG. 8, the 5G synchronization signals appear periodically in the time domain in the form of an SS burst set.

A number of beams actually transmitted by each cell is determined based on a configuration of the network. In some embodiments, as listed in Table 1, the frequency where the cell is located determines a maximum number of configurable beams.

TABLE 1

| Frequency range | L(maximum number of beams) |
|---|---|
| Not greater than 3 (2.4) GHz | 4 |
| 3 (2.4) GHz-6 GHz | 8 |
| 6 GHz-52.6 GHz | 64 |

In radio resource management (RRM) measurements, measurement signals may be based on the SSB. Specifically, the SSS signal or a demodulation reference signal (DMRS) of the PBCH within the SSB is measured to acquire a beam measurement result and a cell measurement result. In additional, the UE in the RRC connected state may further configure a channel state information reference signal (CSI-RS) as a reference signal for cell measurements.

For SSB-based measurements, actual transmission positions of SSBs for various cells may be different, and periods of the SS burst sets may also be different. Therefore, for power saving of the UE in the measurement process, the network configures the SMTC for the UE, and the UE only measures within an SMTC window. For example, as illustrated in FIG. 9, the period of the SSB is 20 ms, the network configures a period of the SMTC as 40 ms and a window length as 5 ms, and the UE only needs to perform an SSB measurement within the 5 ms window.

As the actual transmission positions of SSBs for various cells may be different, the network may further configure an actual transmission position of SSBs for the UE measurement to the UE (for example, a union of actual transmission positions of SSBs of all measured cells) to enable the UE to quickly acquire the actual transmission position of the SSB. For example, as illustrated in FIG. 10, an indication bitmap is 10100110 at 3 to 6 GHz, such that the UE only measures the SSBs with SSB indices (identifiers) of 0, 2, 5, and 6 in the 8 candidate positions.

| | |
|---|---|
| SSB-ToMeasure ::= | CHOICE { |
| shortBitmap | BIT STRING (SIZE (4)), |
| mediumBitmap | BIT STRING (SIZE (8)), |
| longBitmap | BIT STRING (SIZE (64)) |

}

The RRM measurement includes an intra-frequency measurement and an inter-frequency measurement. The intra-frequency measurement refers to a situation where a current serving cell of the UE and a cell for measurement (for example, the candidate cell) are on the same carrier frequency (a center frequency), and the inter-frequency measurement refers to a situation where the current serving cell of the UE and the cell for measurement (for example, the candidate cell) are not on the same carrier frequency.

In the inter-frequency measurement, an MG is required. In a case where the UE needs to perform the inter-frequency measurement (including the inter-system measurement), a simple mode is to dispose two types of radio receivers in the UE device to measure the frequency of the current cell and the frequency of the cell for measurement respectively. However, the mode leads to an increased cost and interference between different frequencies. Therefore, the MG is proposed in the 3GPP, that is, a duration (that is, a duration of the MG) is reserved. In the duration, the UE does not transmit or receive data, adjusts the receiver to the frequency of the cell for measurement to perform the inter-frequency measurement, and returns to the current cell at the end of the gap.

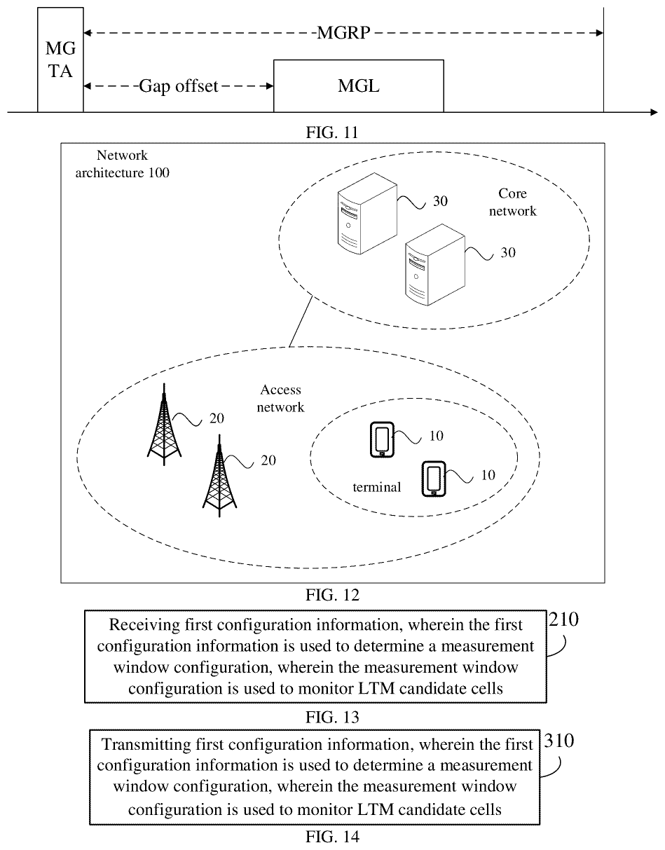

As illustrated in FIG. 11, the measurement configuration information of the MG includes: a measurement gap repetition period (MGRP), a gap offset, a measurement gap length (MGL), a measurement gap timing advance (MGTA), and the like.

The gap offset is an offset of the gap mode. The offset directs to a start subframe within the period, and ranges from 0 to MGRP−1. For example, in a case where the MGRP is 20 ms, the offset ranges from 0 to 19.

The MGL has a unit of ms, and is configured as 1.5, 3, 3.5, 4, 5.5 or 6 ms.

The MGRP has a unit of ms, and is configured as 20, 40, 80 or 160 ms.

For the MGTA, in a case where the parameter is configured, the UE starts a measurement before the gap subframe. That is, the MG is advanced from an MGTA ms to an end of a latest subframe immediately before the MG. The timing advance value is 0.25 ms (a frequency range (FR)2) or 0.5 ms (FR1).

| | |
|---|---|
| GapConfig ::= | SEQUENCE { |
| gapOffset | INTEGER (0..159), |
| mgl | NUMERATED {ms1dot5, ms3, ms3dot5, |
| | ms4, ms5dot5, ms6}, |
| mgrp | ENUMERATED {ms20, ms40, ms80, ms160}, |
| mgta | ENUMERATED {ms0, ms0dot25, ms0dot5}, |

```
  ...,
  [[
```

| | |
|---|---|
| refServCellIndicator | ENUMERATED {pCell, |
| | pSCell, mcg-FR2} OPTIONAL |

-- Cond NEDCorNRDC
]]
}

Illustratively, various types of MG are present, as listed in Table 2.

TABLE 2

| Gap Pattern Id | MGL (ms) | MGRP (ms) |
|---|---|---|
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |

### 3. DC

### 1) Multi-Radio Dual Connectivity (MR-DC)

The MR-DC is a generalized intra evolved universal mobile telecommunications system terrestrial radio access (intra-E-UTRA) DC. The UE uses radio resources provided by two different schedulers that are located at two different next generation radio access network (NG-RAN) nodes and connected via an imperfect backhaul link. One scheduler provides NR access, and the other scheduler provides evolved universal mobile telecommunications system terrestrial radio access (E-UTRA) or NR access. One scheduler acts as the MN, and the other scheduler acts as the SN. The MN is connected to the SN via a network interface, and at least one MN connected to the core network.

2) MR-DC with EPC (that is, a 4G Core Network)

The E-UTRAN supports the MR-DC through E-UTRA-NR dual connectivity (E-UTRA-NR DC). The UE is connected to an eNB acting as the MN and an en-gNB acting as the SN. The eNB is connected to the EPC via the S1 interface and connected to the en-gNB via the X2 interface. The en-gNB is connected to the EPC via the S1-U interface and connected to other en-gNBs via the X2-U interface.

3) MR-DC with 5GC (that is, a 5G Core Network)

### A: The E-UTRA-NR DC (Also Referred to as the NGEN-DC)

The NG-RAN supports NG-RAN E-UTRA-NR DC (also referred to as the NGEN-DC). The UE is connected to an ng-eNB acting as the MN and a gNB acting as the SN. The ng-eNB is connected to the 5GC, and the gNB is connected to the ng-eNB via the Xn interface.

### B: NR-E-UTRA Dual Connectivity (NR-E-UTRA DC, Also Referred to as the NE-DC).

The NG-RAN supports NR-E-UTRA DC. The UE is connected to a gNB acting as the MN and an ng-eNB acting as the SN. The gNB is connected to the 5GC, and the ng-eNB is connected to the gNB via the Xn interface.

### C: NR-NR Dual Connectivity (Also Referred to as the NR DC).

The NG-RAN supports the NR-NR DC. The UE is connected to a gNB acting as the MN and another gNB acting as the SN. The gNB acting as the MN (also referred to as the main gNB) is connected to the 5GC via the NG interface, and the two gNBs are connected to each other via the Xn interface. The gNB acting as the SN (also referred to as the secondary gNB) is also connected to the 5GC via the NG-U interface. In the NR-DC, the UE also accesses a single gNB, and the single gNB acts as the MN and the SN and is configured with a master cell group (MCG) and a secondary cell group (SCG).

In the DC, the UE accesses two cell groups, that is, the MCG and the SCG. The MCG includes a plurality of cells. One of the plurality of cells is used to initiate an initial access and is referred to as a primary cell (PCell). That is, the PCell is the “most important” cell in the MCG. The primary cell in the MCG is referred to as the PCell, and the secondary cell is referred to as the SCell. T primary cell in the SCG is referred to as the PSCell, and the secondary cell is referred to as the SCell. The PCell in the MCG and the SCell in the MCG are jointed via carrier aggregation (CA). As part of signaling is only transmitted on the PCell and PSCell, the PCell and PSCell are collectively referred to as special cells (sPCells) for convenience of description.

Referring to FIG. 12, FIG. 12 is a schematic diagram of a network architecture 100 according to some embodiments of the present disclosure. The network architecture 100 involves a terminal 10, an access network device 20, and a core network device 30.

The terminal 10 refers to as a UE, an access terminal, a subscriber unit, a subscriber station, a rover station, a mobile station, a remote station, a remote terminal, a mobile device, a wireless communication device, a user agent, or a user apparatus. In some embodiments, the terminal 10 is a cellular phone, a cordless phone, a Session Initiation Protocol (SIP) phone, a wireless local loop (WLL) station, a personal digital assistant (PDA) device, a handheld device with a wireless communication function, a computing device or another processing device connected to a wireless modem, an in-vehicle device, a wearable device, a terminal in a 5^{th} generation system (5GS), a terminal in an evolved public land mobile network (PLMN), which is not limited in the embodiments of the present disclosure. For convenient description, the devices are collectively referred to as the terminal. A plurality of terminals 10 are generally disposed, and one or more terminals 10 are disposed in the cell managed by each access network device 20.

The access network device 20 is a device deployed in the access network and configured to provide a wireless communication function for the terminal device 10. The access network device 20 includes various types of macro base stations, micro base stations, relay stations, access points, and the like. In systems using different radio access technologies, the devices with the functionality of the access network device have different names, for example, gNodeBs or gNBs in 5G NR systems. With the evolution of communications technologies, the name “access network device” varies. For convenient description, the devices providing the wireless communication function for the terminal 10 are collectively referred to as the access network device in the embodiments of the present disclosure. In some embodiments, the terminal 10 is in communication with the core network device 30 via the access network device 20. Illustratively, in the LTE system, the access network device 20 is an evolved universal terrestrial radio access network (EUTRAN) or one or more evolved NodeBs (eNodeBs) in the EUTRAN; and in the 5G NR system, the access network device 20 is a radio access network (RAN) or one or more gNBs in the RAN.

The access network device in the 3^{rd} generation (3G) communication system is also referred to as a NodeB (NB). The access network device in the 4^{th} generation (4G) communication systems is also referred to as the eNodeB (eNB). In Option 4 series of non-standalone (NSA) architecture, the 4G access network device needs to be upgraded to support the eLTE and interface with the 5G core network. The upgraded 4G access network device is also referred to as the ng-eNB. The access network device in the 5G communication system is also referred to as gNB. In the NAS Option 3 series, as the 5G access network device needs to access the 4G core network, the 5G gNB needs to be modified to interface with the 4G core network. The modified gNB is also referred to as the en-gNB.

The core network device 30 is deployed in the core network. The core network device mainly functions to provide user connection, user management, and service bearing, and acts as a bearer network for providing an interface to an external network. For example, the core network device in the 5G NR system includes an access and mobility management function (AMF) network element, an authentication server function (AUSF) network element, a user plane function (UPF) network element, a session management function (SMF) network element, a location management function (LMF) network element, a policy control function (PCF) network element, a unified data management (UDM) network element, and the like.

For example, the access network device 20 and the core network device 30 communicate with each other using the air interface technology, for example, an NG interface in the 5G NR system. The access network device 20 and the terminal device 10 communicate with each other using the air interface technology, such as a Uu interface.

The access network device is an access device through which the terminal accesses the network architecture in the wireless mode, and mainly provides wireless resource management on the air interface, quality of service (QoS) management, data compression and encryption, and the like. For example, the access network device is an NodeB, an eNodeB, an NodeB in the 5G mobile communication system or the NR communication system, an NodeB in future mobile communication system, and the like.

The “5G NR system” in the embodiments of the present disclosure is also referred to as a 5G system or an NR system, and those skilled in the art may understand the meaning. The technical solutions according to the embodiments of the present disclosure are applicable to the LTE system, the 5G NR system, evolved systems of the 5G NR system, the narrow-band Internet of things (NB-IoT) system and other communication systems, which is not limited in the present disclosure.

Referring to FIG. 13, FIG. 13 is a flowchart of a method for configuring a measurement window according to some embodiments of the present disclosure. The method is performed by a terminal. The method includes the following process.

In S210, first configuration information is received, wherein the first configuration information is used to determine a measurement window configuration, wherein the measurement window configuration is used to monitor LTM candidate cells.

The terminal receives the first configuration information from the network device, and the first configuration information is carried in an RRC message, for example, an RRC reconfiguration message.

The first configuration information is used to determine a measurement window for performing the L1 measurement, or, the first configuration information is used to determine a measurement window for measuring the LTM candidate cells.

In some embodiments, the first configuration information includes the measurement window configuration (or referred to as an L1 measurement window configuration, an LTM measurement window configuration, or the like). The measurement window configuration is used to configure the measurement window for the LTM candidate cells, or, the measurement window is used to configure the measurement window for the L1 measurement. The terminal determines the measurement window for monitoring the LTM candidate cells.

In some embodiments, the first configuration information includes a first measurement window configuration (or referred to as an L3 measurement window configuration, an SMTC, an MG configuration, or the like). The first measurement window configuration is used to configure the measurement window for the L3 measurement. The first measurement window configuration is allowed to perform the L1 measurement, or, the first measurement window configuration is allowed to measure the LTM candidate cells. The terminal determines the measurement window configuration of the L1 measurement based on the first measurement window configuration, and determines the measurement window for monitoring the LTM candidate cells based on the first measurement window configuration.

In some embodiments, the first configuration information includes a first measurement window configuration (or referred to as an L3 measurement window configuration, an SMTC, an MG configuration, or the like) and a second measurement window configuration. The first measurement window configuration is used to configure the measurement window for the L3 measurement, and the second measurement window configuration is used to configure the measurement window for the L1 measurement. The terminal determines the measurement window configuration of the L1 measurement based on the first measurement window configuration or the second measurement window configuration.

For example, the second measurement window configuration only includes part of configuration information of the measurement window configuration of the L1 measurement, and remaining configuration information of the measurement window configuration uses corresponding configuration in the first measurement window configuration. For example, the measurement window configuration of the L1 measurement includes a measurement period of the measurement window, a measurement offset of the measurement window, and a measurement length of the measurement window. The second measurement window configuration includes the measurement offset of the measurement window, and the measurement period of the measurement window and the measurement length of the measurement window use a corresponding configuration in the first measurement window configuration. The terminal monitors the LTM candidate cells based on the first measurement window configuration and the second measurement window configuration.

Alternatively, the second measurement window configuration is the MG configuration, the first measurement window configuration is the SMTC, and then the measurement window configuration of the L1 measurement includes the first measurement window configuration and the second measurement window configuration. The terminal determines the measurement window for the L1 measurement based on the MG configuration the SMTC.

Illustratively, the measurement window configuration includes at least one of a first-type configuration, a second-type configuration, or a third-type configuration. The first-type configuration is used to configure the MG, and the terminal suspends data communication with a serving cell within the MG. The second-type configuration includes the SMTC, and the third-type configuration is used to configure the measurement window for the L1 measurement.

Any one of the first-type configuration, the second-type configuration, or the third-type configuration includes at least one of a measurement period of the measurement window (a window repetition period), a measurement offset of the measurement window, a measurement length of the measurement window, or a downlink timing reference.

The measurement offset includes at least one of a state offset or a start offset difference.

For calculation of a start time of the measurement window, reference may be made to a system frame number (SFN) and a subframe of the candidate cell and an SFN and a subframe of the serving cell.

A reference time of the state offset is an SFN and a subframe of the current serving cell, and a start position of the measurement window is the SFN plus a start offset.

The start offset difference is a difference in a start offset between the candidate cell for measurement and the serving cell. The start offset of the measurement window of the candidate cell for measurement is determined based on a start offset in the measurement window configuration of the serving cell. For example, the measurement window configuration of the serving cell includes a first start offset, and the candidate cell and the serving cell correspond to a first start offset difference, and then a second start offset corresponding to the candidate cell is a sum of the first start offset and the first start offset difference. A start position of the measurement window of the candidate cell is the SFN of the serving cell plus the second start offset.

Illustratively, the serving cell is a cell that the terminal currently accesses. For example, in a case where the candidate cell is a candidate cell of the primary cell, the serving cell is the primary cell that the terminal currently accesses; and in a case where the candidate cell is a candidate cell of the primary secondary cell, the serving cell is the primary secondary cell that the terminal currently accesses.

The start offset difference is further a difference in the start offset between the candidate cell for measurement and the reference serving cell. The start offset of the measurement window of the candidate cell for measurement is determined based on the start offset in the reference measurement window configuration of the reference serving cell. For example, the reference measurement window configuration of the reference serving cell includes a third start offset, and the candidate cell and the reference serving cell correspond to the second start offset difference, and then a fourth start offset corresponding to the candidate cell is a sum of the third start offset and the second start offset difference. A start position of the measurement window of the candidate cell is the SFN of the reference serving cell plus the fourth start offset.

Illustratively, the measurement window configuration of each serving cell uses a differential configuration mode. That is, a serving cell is determined as a reference serving cell, and the reference measurement window configuration is configured for the reference serving cell. Other serving cells use the differential configuration mode, a differential measurement window configuration is configured for the other serving cells, and the measurement window configuration of the other serving cells includes the reference measurement window configuration and the differential measurement window configuration. For example, the primary cell is determined as the reference serving cell, and the start offset of the primary cell is 2. In a case where the start offset of the primary secondary cell is 3, the start offset in the differential measurement window configuration of the primary secondary cell (or referred to as a start offset differential) is 1, and the start offset of the primary secondary cell is 2+1=3 based on the reference measurement window configuration of the primary cell and the differential measurement window configuration of the primary secondary cell.

The measurement offset and/or the downlink timing reference are used to determine the start position of the measurement window.

For example, the first-type configuration includes the MG configuration, and the MG configuration includes at least one of a measurement gap repetition period (MGRP), a gap offset, a measurement gap length (MGL), or a measurement gap timing advance (MGTA).

For example, the second-type configuration is the SMTC, and the SMTC includes at least one of a measurement period of the measurement window, a measurement offset of the measurement window, a measurement length of the measurement window, or a downlink timing reference.

For example, the third-type configuration is an L1 measurement window configuration, wherein the L1 measurement window configuration includes at least one of a measurement period of the measurement window, a measurement offset of the measurement window, a measurement length of the measurement window, or a downlink timing reference.

The first-type configuration is contained in the L3 measurement window configuration, and is further contained in the L1 measurement window configuration. In a case where the first-type configuration is the L3 measurement window configuration, the first-type configuration is allowed to perform the L1 measurement. The second-type configuration is contained in the L3 measurement window configuration, and is further contained in the L1 measurement window configuration. In a case where the second-type configuration is the L3 measurement window configuration, the second-type configuration is allowed to perform the L1 measurement. The third-type configuration is contained in the L1 measurement window configuration.

That is, the measurement window configuration includes at least one of the MG configuration, the SMTC, or the L1 measurement window configuration.

Illustratively, the measurement window configuration is used to perform at least one of the L1 measurement or the L3 measurement. For example, the measurement window configuration is used to perform the L1 measurement, and the terminal is further used for the measurement window to perform the L3 measurement.

Illustratively, the measurement window configuration is used to monitor at least one of a serving cell, a neighbor cell, or a candidate cell. The candidate cell is also referred to as an LTM candidate cell, and is allowed to be monitored through the L1 measurement.

Illustratively, the first configuration information is used several times, and the terminal maintains the first configuration information upon a cell switch and continues to use the first configuration information to monitor the LTM candidate cell.

In summary, in the embodiments of the present disclosure, the terminal receives the first configuration information to determine the measurement window configuration. The measurement window configuration is used to monitor LTM candidate cells. The terminal performs the L1 measurement based on the measurement window and directly reports the L1 measurement result to the network device, such that the latency of the cell measurement is reduced, and the efficiency of the cell measurement is improved.

Referring to FIG. 14, FIG. 14 is a flowchart of a method for configuring a measurement window according to some embodiments of the present disclosure. The method is performed by a network device. The method includes the following process.

In S310, first configuration information is transmitted, wherein the first configuration information is used to determine a measurement window configuration, wherein the measurement window configuration is used to monitor LTM candidate cells.

The network device is an access network device corresponding to the serving cell of the terminal, or a core network device.

Illustratively, the first configuration information further includes at least one of a reference signal configuration for measurement, a measurement object configuration, or a measurement report configuration.

The reference signal configuration for measurement is at least one of an SSS in an SSB, a DMRS in the PBCH, or a CSI-RS. The reference signal configuration for measurement includes a reference signal resource for measurement, a reference signal period, or a reference signal start position.

The measurement object is at least one of a frequency, a candidate cell, or a candidate cell group. The measurement report configuration is used to configure a report mode of a measurement result.

Illustratively, the configuration granularity of the first configuration information is at least one of an independent configuration for each candidate cell, an independent configuration for each candidate cell group, using a same set of first configuration information for all the candidate cells, an independent configuration per frequency, or an independent configuration for each bandwidth part (BWP).

That is, the first configuration information includes at least one of a set of configuration information corresponding to each candidate cell, a set of configuration information corresponding to each candidate cell group, a set of configuration information shared by all the candidate cells, a set of configuration information corresponding to each frequency, or a set of configuration information corresponding to each BWP. The set of first configuration information includes at least one of the measurement window configuration, the reference signal configuration for measurement, the measurement object configuration, or the measurement report configuration.

Illustratively, the first configuration information is determined based on at least one of a serving cell measurement configuration, a candidate cell reference configuration, a combination of a candidate cell reference configuration and a candidate cell differential configuration, or an LTM configuration.

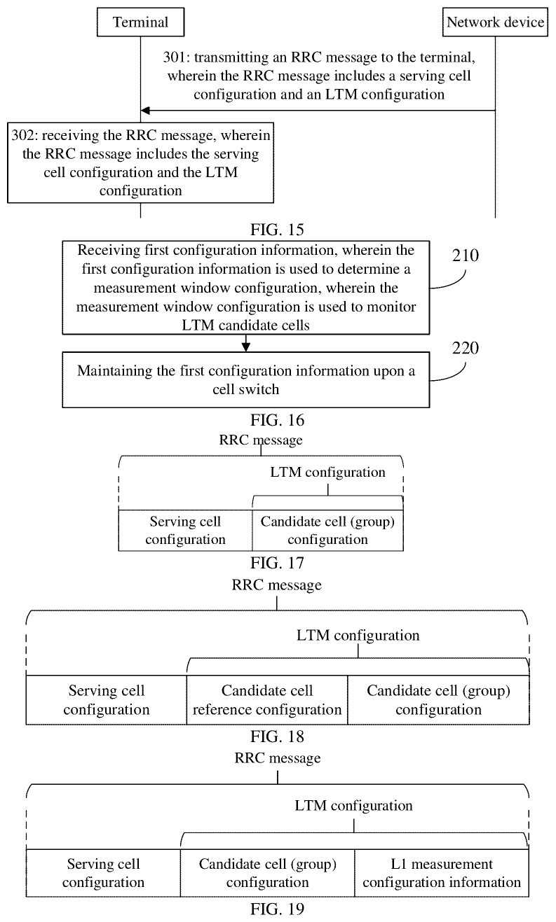

Illustratively, the network device transmits the RRC message to the terminal. The RRC message carries a serving cell configuration and an LTM configuration. The LTM configuration includes the candidate cell configuration. For example, as illustrated in FIG. 15, in S301, the network device transmits the RRC message to the terminal, and the RRC message carries a serving cell configuration and an LTM configuration; and in S302, the terminal receives the RRC message, wherein the RRC message carries a serving cell configuration and an LTM configuration.

In some embodiments, the first configuration information is determined based on the serving cell measurement configuration in the serving cell configuration, that is, the measurement configuration of the L1 measurement shares the measurement configuration of the L3 measurement. The serving cell measurement configuration includes the measurement window configuration of the serving cell, and the measurement window configuration of the serving cell is used to perform the L1 measurement and monitor the LTM candidate cells.

In some embodiments, the first configuration information is determined based on the candidate cell reference configuration. The candidate cell configuration (the candidate cell reference configuration or the candidate cell differential configuration) includes candidate cell measurement configuration information. The candidate cell configuration defines the candidate cell reference configuration for the reference candidate cell via a differential configuration mode, and configures the candidate cell differential configuration for other candidate cells. The candidate cell configuration of the other candidate cells includes the candidate cell reference configuration and the candidate cell differential configuration. The first configuration information is determined based on the candidate cell reference configuration, and the candidate cell reference configuration includes the measurement window configuration used to perform the L1 measurement. All the candidate cells may share the measurement window configuration to perform the L1 measurement.

In some embodiments, the first configuration information is determined based on the candidate cell reference configuration and the candidate cell differential configuration. The L1 measurement is performed on different candidate cells using different measurement window configurations. For example, for a first candidate cell, the first configuration information corresponding to the first candidate cell is determined based on the candidate cell reference configuration and the first candidate cell differential configuration corresponding to the first candidate cell.

In some embodiments, the first configuration information is determined based on the LTM configuration. The LTM configuration further includes the candidate cell measurement configuration information, and the first configuration information is determined based on the candidate cell measurement configuration information. That is, the candidate cell configuration and the candidate cell measurement configuration information are separately configured. The candidate cell measurement configuration is shared by all the candidate cells, and all the candidate cells share the configuration. Alternatively, the measurement configuration is separately configured for each candidate cell, and each candidate cell uses the configuration thereof.

In summary, in the embodiments of the present disclosure, the terminal receives the first configuration information to determine the measurement window configuration. The measurement window configuration is used to monitor LTM candidate cells. The terminal performs the L1 measurement based on the measurement window and directly reports the L1 measurement result to the network device, such that the latency of the cell measurement is reduced, and the efficiency of the cell measurement is improved.

Illustratively, the terminal continues to use the first configuration information to perform the L1 measurement upon a cell switch, such that the terminal efficiently monitors the candidate cell in the ping-pong switch scenario.

Referring to FIG. 16, FIG. 16 is a flowchart of a method for configuring a measurement window according to some embodiments of the present disclosure. The method is performed by a terminal. The method includes the following process.

In S210, first configuration information is received, wherein the first configuration information is used to determine a measurement window configuration, wherein the measurement window configuration is used to monitor LTM candidate cells.

Illustratively, the first configuration information includes a candidate cell configuration and measurement configuration information for performing the L1 measurement, wherein the measurement configuration information is used to determine the measurement window configuration.

Illustratively, the measurement configuration information is shared by all the candidate cells (frequencies). In performing the L1 measurement on the first candidate cell, the L1 measurement of the first candidate cell is performed based on the shared measurement configuration information and the downlink timing reference corresponding to the first candidate cell.

Illustratively, the measurement configuration information is separately configured for each candidate cell (frequency). That is, the measurement configuration information includes at least one group of measurement configurations in one-to-one correspondence with at least one candidate cell. In performing the L1 measurement on the first candidate cell, the L1 measurement of the first candidate cell is performed based on the measurement configuration information corresponding to the first candidate cell.

In a case where the measurement configuration information is the shared measurement configuration information, the measurement configuration information is determined based on the serving cell measurement configuration in the serving cell configuration; the measurement configuration information is further determined based on the candidate cell reference configuration in the candidate cell configuration; and the measurement configuration information is further determined based on the separately configured L1 measurement configuration information, and the L1 measurement configuration information includes the measurement configuration information shared by all the candidate cells.

In a case where the measurement configuration information is separately configured for each candidate cell (frequency), the measurement configuration information of the L1 measurement corresponding to the candidate cell is determined based on the serving cell measurement configuration and the candidate cell candidate cell configuration; the candidate cell measurement configuration information is further determined based on the candidate cell candidate cell configuration; and the candidate cell measurement configuration information is further determined based on the separately configured L1 measurement configuration information, and the L1 measurement configuration information includes the measurement configuration information corresponding to each candidate cell.

Example 1, as illustrated in FIG. 17, the terminal receives the RRC message, and the RRC message carries a serving cell configuration and an LTM configuration. The LTM configuration includes the candidate cell (group) configuration.

The measurement configuration information for performing the L1 measurement is determined based on (1) the serving cell configuration, (2) the candidate cell configuration, or (3) the serving cell configuration and the candidate cell configuration.

As the measurement configuration information includes the measurement window configuration, the measurement window configuration for performing the L1 measurement is determined based on the serving cell configuration, the candidate cell configuration, or the serving cell configuration and the candidate cell configuration.
(1) The measurement window configuration for performing the L1 measurement is determined based on the serving cell configuration.
a. The terminal determines the measurement configuration information of the L1 measurement based on the initial serving cell configuration (the serving cell measurement configuration in the serving cell configuration), does not change the measurement configuration information upon a cell switch, and still uses the serving cell measurement configuration in the initial serving cell configuration as the measurement configuration information for performing the L1 measurement.

The initial serving cell configuration is a serving cell configuration of the serving cell that the terminal accesses in receiving the RRC message. For example, the serving cell that the terminal accesses in receiving the RRC message is a first cell, the terminal performs the L1 measurement using a serving cell measurement configuration of the first cell, wherein the serving cell measurement configuration of the first cell is the measurement configuration information for performing the L1 measurement. That is, upon a cell switch (for example, a switch from the first cell to the second cell), the terminal does not change the measurement configuration information of the L1 measurement, and still uses the serving cell measurement configuration of the first cell as the measurement configuration information of the L1 measurement.
b. The terminal determines the measurement configuration information of the L1 measurement based on the serving cell configuration (the serving cell measurement configuration in the serving cell configuration) of the current serving cell, and updates the measurement configuration information based on the serving cell measurement configuration corresponding to the new serving cell upon a cell switch. That is, the measurement configuration information of the L1 measurement is always determined based on the serving cell configuration of the serving cell that the terminal currently accesses.

For example, the serving cell that the terminal previously accesses is a first cell, and the previous measurement configuration information of the L1 measurement is a serving cell measurement configuration of the first cell; and in a case where the serving cell that the terminal accesses switches from the first cell to a second cell, the measurement configuration information of the L1 measurement updates to a serving cell measurement configuration of the second cell.

The serving cell measurement configuration of the new serving cell (the target cell) is acquired from the candidate cell configuration. For example, the second cell is the candidate cell previously, and the terminal acquires the candidate cell configuration corresponding to the second cell from the candidate cell configuration of the RRC message in a case where the second cell is determined as the target cell. Upon a cell switch, the second cell is the serving cell, the candidate cell configuration corresponding to the second cell is determined as the serving cell configuration, and the terminal determines the measurement configuration information of the L1 measurement based on the serving cell configuration of the second cell.

In a case where the candidate cell configuration uses the differential configuration mode, the serving cell configuration of the new serving cell (the target cell) includes the candidate cell reference configuration and the candidate cell differential configuration corresponding to the target cell in the candidate cell configuration. Then the measurement configuration information of the L1 measurement is determined based on the candidate cell reference configuration and the candidate cell configuration (the candidate cell differential configuration corresponding to the target cell).

Illustratively, in a case where the measurement configuration information of the L1 measurement is determined based on the serving cell configuration, the terminal performs the L1 measurement on each candidate cell based on the measurement configuration information and the downlink timing reference corresponding to each candidate cell (the downlink timing reference corresponding to the candidate cell is carried in the candidate cell configuration).

For example, the serving cell configuration includes the configuration information of measurement window 1, and the L1 measurement for the first candidate cell is performed based on configuration information of measurement window 1 and the downlink timing reference of the first candidate cell.
(2) The measurement window configuration for performing the L1 measurement is determined based on the candidate cell configuration, that is, the measurement configuration information of the L1 measurement is determined based on the candidate cell configuration.
a. The measurement configuration information is measurement configuration information shared by all the candidate cells. The candidate cell configuration includes a candidate cell reference configuration, and the measurement configuration information of the L1 measurement is measurement configuration information in the candidate cell reference configuration. In performing the L1 measurement on the first candidate cell, the signal monitoring is performed based on the measurement configuration information of the L1 measurement and the downlink timing reference of the first candidate cell.

In this case, the measurement configuration information is still used upon a cell switch, and is not updated.
b. The measurement configuration information is measurement configuration information configured for each candidate cell. The candidate cell configuration includes measurement configuration information corresponding to each candidate cell. In performing the L1 measurement on the first candidate cell, the signal monitoring is performed based on the measurement configuration information corresponding to the first candidate cell in the candidate cell configuration.

In this case, the measurement configuration information corresponding to each candidate cell is still used upon a cell switch, and is not updated.
(3) The measurement window configuration for performing the L1 measurement is determined based on the serving cell configuration and the candidate cell configuration.

In a case, the candidate cell configuration is configured with reference to the serving cell configuration. That is, the serving cell configuration is determined as the candidate cell reference configuration, and the candidate cell configuration includes a candidate cell differential configuration of each candidate cell. Then the candidate cell configuration of the first candidate cell includes the serving cell configuration (the candidate cell reference configuration) and the candidate cell differential configuration corresponding to the first candidate cell in the candidate cell configuration.

In this case, the measurement configuration information of the L1 measurement includes a set of measurement configuration information configured for each candidate cell. For example, the measurement configuration information corresponding to the first candidate cell includes the serving cell measurement configuration in the serving cell configuration and the candidate cell measurement configuration corresponding to the first candidate cell in the candidate cell configuration.

Upon a cell switch, the serving cell configuration and the candidate cell configuration of another candidate cell are updated based on the candidate cell configuration of the target cell (the candidate cell indicated as the switching target). For example, before the switch, a first field in the serving cell configuration takes a value of 3, an increment of the first field in the candidate cell differential configuration of the target cell is 1 (that is, the first field of the target cell takes a value of 3+1=4), and an increment of the first field in the candidate cell differential configuration of the first candidate cell is 5 (that is, the first field of the first candidate cell takes a value 3+5=8). Then, in a case where the serving cell is switched to the target cell, the value of the first field in the serving cell configuration is updated to 3+1=4. Correspondingly, the increment of the first field in the candidate cell differential configuration of the first candidate cell is updated to 4 (that is, the first field of the first candidate cell takes a value 4+4=8).

Example 2, the candidate cell configuration uses the differential configuration mode, that is, the network device configures the candidate cell reference configuration and the candidate cell configuration (the candidate cell differential configuration) corresponding to each candidate cell. The candidate cell configuration of the first candidate cell includes the candidate cell reference configuration and the candidate cell differential configuration corresponding to the first candidate cell.

As illustrated in FIG. 18, the terminal receives the RRC message, wherein the RRC message carries a serving cell configuration and an LTM configuration. The LTM configuration includes the candidate cell reference configuration and the candidate cell (group) configuration. The candidate cell (group) configuration includes the candidate cell differential configuration corresponding to each candidate cell. The complete candidate cell configuration information includes the candidate cell reference configuration and the candidate cell differential configuration corresponding to the candidate cell.

The measurement configuration information for performing the L1 measurement is determined based on (1) the serving cell configuration or (2) the candidate cell reference configuration and the candidate cell configuration.

As the measurement configuration information includes the measurement window configuration, the measurement window configuration for performing the L1 measurement is determined based on the serving cell configuration or the candidate cell reference configuration and the candidate cell configuration.
(1) The measurement window configuration for performing the L1 measurement is determined based on the serving cell configuration. For details, reference may be made to related description in example 1.

It should be noted that in a case where the measurement configuration information of the L1 measurement is determined based on the serving cell configuration of the current serving cell, upon a cell switch, the serving cell configuration corresponding to the target cell (the current serving cell upon a cell switch) includes the candidate cell reference configuration and the candidate cell differential configuration corresponding to the target cell in the candidate cell configuration.
(2) The measurement window configuration for performing the L1 measurement is determined based on the candidate cell reference configuration and the candidate cell configuration (the candidate cell differential configuration). That is, the measurement configuration information of the L1 measurement is determined based on the candidate cell configuration.
a. The measurement configuration information is measurement configuration information shared by all the candidate cells. The measurement configuration information of the L1 measurement is the measurement configuration information in the candidate cell reference configuration. In performing the L1 measurement on the first candidate cell, the signal monitoring is performed based on the measurement configuration information of the L1 measurement and the downlink timing reference of the first candidate cell.

In this case, the measurement configuration information is still used upon a cell switch, and is not updated.
b. The measurement configuration information includes measurement configuration information configured for each candidate cell. The candidate cell measurement configuration information includes measurement configuration information in the candidate cell reference configuration and measurement configuration information in the candidate cell differential configuration corresponding to the candidate cell in the candidate cell configuration. In performing the L1 measurement on the first candidate cell, the signal monitoring is performed based on the candidate cell reference configuration and the candidate cell differential configuration corresponding to the first candidate cell in the candidate cell configuration.

In this case, the measurement configuration information corresponding to each candidate cell is still used upon a cell switch, and is not updated.

Example 3, the network device separately configures the L1 measurement configuration information (not in the cell configuration). As illustrated in FIG. 19, the terminal receives the RRC message, wherein the RRC message carries a serving cell configuration and an LTM configuration. The LTM configuration includes the candidate cell (group) configuration and the L1 measurement configuration information.

The measurement configuration information for performing the L1 measurement is determined based on (1) the serving cell configuration, (2) the L1 measurement configuration information, (3) a combination of the L1 measurement configuration information and the candidate cell configuration, or (4) a combination of the L1 measurement configuration information and the serving cell configuration.

As the measurement configuration information includes the measurement window configuration, the measurement window configuration for performing the L1 measurement is determined based on the serving cell configuration, the L1 measurement configuration information, or a combination of the L1 measurement configuration information and the candidate cell configuration.
(1) The measurement window configuration for performing the L1 measurement is determined based on the serving cell configuration. For details, reference may be made to related description in example 1.
(2) The measurement window configuration for performing the L1 measurement is determined based on the L1 measurement configuration information.
a. The L1 measurement configuration information includes measurement configuration information shared by all the candidate cells.

In performing the L1 measurement on the first candidate cell, the signal monitoring is performed based on the L1 measurement configuration information (the measurement configuration information) and the downlink timing reference of the first candidate cell.

In this case, the previous measurement configuration information is still used upon a cell switch, and is not updated.
b. The L1 measurement configuration information includes measurement configuration information configured for each candidate cell.

In performing the L1 measurement on the first candidate cell, the signal monitoring is performed based on the measurement configuration information corresponding to the first candidate cell in the L1 measurement configuration information.

In this case, the measurement configuration information corresponding to each candidate cell is still used upon a cell switch, and is not updated.
c. The L1 measurement configuration information includes reference measurement configuration information and the differential measurement configuration information corresponding to each candidate cell. The candidate cell measurement configuration information includes the reference measurement configuration information and the differential measurement configuration information corresponding to the candidate cell.

In performing the L1 measurement on the first candidate cell, the signal monitoring is performed based on the reference measurement configuration information and the differential measurement configuration information corresponding to the first candidate cell.

In this case, the reference measurement configuration information and the differential measurement configuration information corresponding to the candidate cell are still used upon a cell switch, and the measurement configuration information is not updated.
(3) The measurement window configuration for performing the L1 measurement is determined based on the L1 measurement configuration information and the candidate cell configuration.

Illustratively, the candidate cell measurement configuration information uses the differential configuration mode, the L1 measurement configuration information is determined as the reference configuration, and the candidate cell configuration includes the differential configuration corresponding to each candidate cell. Then the measurement configuration information corresponding to the candidate cell includes the L1 measurement configuration information and the differential configuration correlated with the measurement configuration information corresponding to the candidate cell in the candidate cell configuration.

The measurement configuration information includes measurement configuration information configured for each candidate cell. The candidate cell measurement configuration information includes the L1 measurement configuration information and the measurement configuration information in the differential configuration corresponding to the candidate cell in the candidate cell configuration. In performing the L1 measurement on the first candidate cell, the signal monitoring is performed based on the L1 measurement configuration information and the differential configuration corresponding to the first candidate cell in the candidate cell configuration.

In this case, the measurement configuration information configured for each candidate cell is still used upon a cell switch, and is not updated.
(4) The measurement window configuration for performing the L1 measurement is determined based on the L1 measurement configuration information and the serving cell configuration.

Illustratively, the candidate cell measurement configuration information uses the differential configuration mode, the serving cell measurement configuration in the serving cell configuration is determined as the reference configuration, and the L1 measurement configuration information includes the differential configuration corresponding to each candidate cell. Then the measurement configuration information corresponding to the candidate cell includes the serving cell measurement configuration and the differential configuration corresponding to the candidate cell in the L1 measurement configuration information.

The measurement configuration information includes measurement configuration information configured for each candidate cell. The candidate cell measurement configuration information is the serving cell measurement configuration and the differential configuration corresponding to the candidate cell in the L1 measurement configuration information. In performing the L1 measurement on the first candidate cell, the signal monitoring is performed based on the serving cell measurement configuration and the differential configuration corresponding to the first candidate cell in the L1 measurement configuration information.

In this case, upon a cell switch, the serving cell configuration is updated to the candidate cell configuration of the target cell, and the terminal updates the L1 measurement configuration information based on the candidate cell configuration of the target cell. For example, before the switch, a first field in the serving cell configuration takes a value of 3, a first field in the candidate cell configuration of the target cell takes a value of 4, and an increment of the first field corresponding to the first candidate cell in the L1 measurement configuration information is 5 (that is, the first field of the first candidate cell takes a value of 3+5=8). Then, in a case where the serving cell is switched to the target cell, the value of the first field in the serving cell configuration is updated to 4. Correspondingly, the increment of the first field corresponding to the first candidate cell in the L1 measurement configuration information is updated to 4 (that is, the first field of the first candidate cell takes a value 4+4=8).

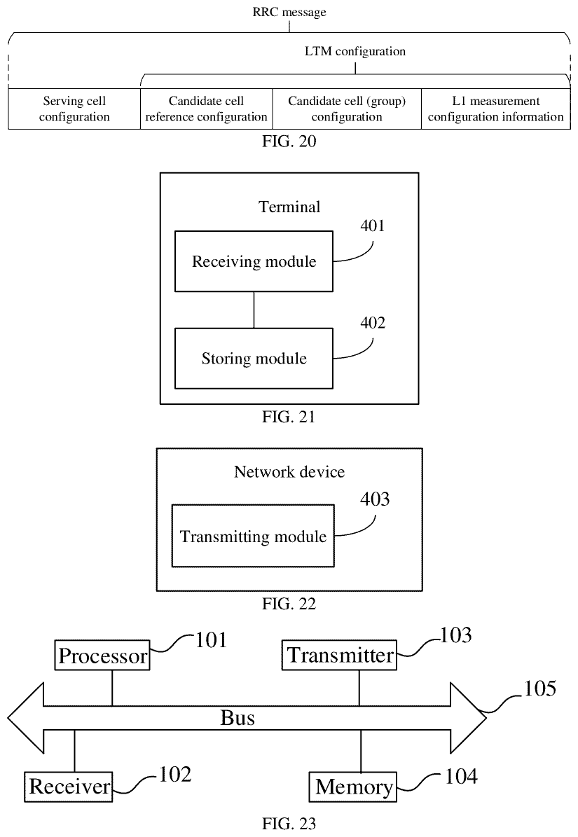

Example 4, on the basis of example 3, in a case where the candidate cell configuration uses the differential configuration mode, as illustrated in FIG. 20, the terminal receives the RRC message, and the RRC message carries the serving cell configuration and the LTM configuration. The LTM configuration includes the candidate cell reference configuration, the candidate cell (group) configuration, and the L1 measurement configuration information.

The measurement configuration information for performing the L1 measurement is determined based on (1) the serving cell configuration, (2) the L1 measurement configuration information, (3) a combination of the L1 measurement configuration information and the candidate cell configuration, (4) a combination of the L1 measurement configuration information and the serving cell configuration, (5) a combination of the candidate cell reference configuration and the candidate cell configuration, or (6) the candidate cell configuration.

As the measurement configuration information includes the measurement window configuration, the measurement window configuration for performing the L1 measurement is determined based on the serving cell configuration, the L1 measurement configuration information, the L1 measurement configuration information and the candidate cell configuration, the L1 measurement configuration information and the serving cell configuration, or the candidate cell reference configuration and the candidate cell configuration.
(1) The measurement window configuration for performing the L1 measurement is determined based on the serving cell configuration. For details, reference may be made to related description in example 1.
(2) The measurement window configuration for performing the L1 measurement is determined based on the L1 measurement configuration information. For details, reference may be made to related description in example 3.
(3) The measurement window configuration for performing the L1 measurement is determined based on the L1 measurement configuration information and the candidate cell configuration. For details, reference may be made to related description in example 3.
(4) The measurement window configuration for performing the L1 measurement is determined based on the L1 measurement configuration information and the serving cell configuration. For details, reference may be made to related description in example 3.
(5) The measurement window configuration for performing the L1 measurement is determined based on the candidate cell reference configuration and the candidate cell configuration. For details, reference may be made to related description in example 2.
(6) The measurement window configuration for performing the L1 measurement is determined based on the candidate cell configuration. For details, reference may be made to related description in example 1.

Thus, the measurement configuration information/the measurement window configuration is determined based on at least one of:
mode 1) the serving cell measurement configuration;
mode 2) a combination of the serving cell measurement configuration and the candidate cell configuration;
mode 3) the L1 measurement configuration information;
mode 4) a combination of the serving cell measurement configuration and the L1 measurement configuration information; or
mode 5) a combination of the candidate cell configuration and the L1 measurement configuration information.

Mode 1) The measurement configuration information is determined based on the serving cell measurement configuration in the serving cell configuration.

Illustratively, the measurement window configuration is determined based on the serving cell measurement configuration in the serving cell configuration.

For example, the serving cell configuration includes the measurement window configuration of the serving cell. For example, the measurement window configuration of the serving cell includes the MG configuration and/or the SMTC. The measurement window configuration of the L1 measurement shares the MG configuration and/or the SMTC.

Illustratively, the serving cell configuration is an initial serving cell configuration, that is, the serving cell configuration configured in the RRC message. In a case where the measurement configuration information is determined based on the initial serving cell configuration, the measurement configuration information is unchanged upon a cell switch.

Illustratively, the serving cell configuration is a serving cell configuration of the currently accessed serving cell. In this case, the measurement configuration information is updated/replaced based on the serving cell configuration corresponding to the new serving cell upon a cell switch.

Mode 2) The measurement configuration information is determined based on the serving cell measurement configuration and the candidate cell configuration. The serving cell configuration includes the serving cell measurement configuration, and the serving cell measurement configuration includes the measurement window configuration of the serving cell.

Illustratively, the serving cell configuration is an initial serving cell configuration or a serving cell configuration of the currently accessed serving cell.

The candidate cell configuration includes candidate cell measurement configuration information. In some embodiments, the candidate cell configuration includes configuration information of at least one candidate cell, and the configuration information of each candidate cell includes at least one piece of measurement configuration information corresponding to the candidate cell. In some embodiments, the candidate cell configuration includes differential measurement configuration information of at least one candidate cell, and further includes reference measurement configuration information shared by all the candidate cells. In some embodiments, the candidate cell configuration includes configuration information of at least one candidate cell group, the configuration information of each candidate cell group includes measurement configuration information corresponding to the candidate cell group, and candidate cells belonging to the candidate cell group share the measurement configuration information. In some embodiments, the candidate cell configuration includes differential measurement configuration information of at least one candidate cell group, and further includes reference measurement configuration information shared by all candidate cell groups.

The candidate cell configuration includes a candidate cell measurement window configuration. In some embodiments, the candidate cell configuration includes configuration information of at least one candidate cell, and the configuration information of each candidate cell includes at least one measurement window configuration corresponding to the candidate cell. In some embodiments, the candidate cell configuration includes a differential measurement window configuration of at least one candidate cell, and further includes a reference measurement window configuration shared by all the candidate cells. In some embodiments, the candidate cell configuration includes configuration information of at least one candidate cell group, the configuration information of each candidate cell group includes the measurement window configuration corresponding to the candidate cell group, and candidate cells belonging to the candidate cell group share the measurement window configuration. In some embodiments, the candidate cell configuration includes a differential measurement window configuration of at least one candidate cell group, and further includes a reference measurement window configuration shared by all candidate cell groups.

For example, the measurement configuration information of the L1 measurement uses the differential configuration mode.

In the differential configuration mode, the candidate cell reference configuration and the candidate cell configuration are configured in the LTM configuration. The candidate cell reference configuration includes reference measurement configuration information shared by all the candidate cells, and the candidate cell configuration includes differential measurement configuration information corresponding to each candidate cell. Then the measurement configuration information of the L1 measurement corresponding to the candidate cell includes the reference measurement configuration information and the differential measurement configuration information corresponding to the candidate cell.

In the differential configuration mode, the L1 measurement configuration information and the candidate cell configuration are configured in the LTM configuration. The L1 measurement configuration information is reference measurement configuration information shared by all the candidate cells, and the candidate cell configuration includes differential measurement configuration information corresponding to each candidate cell. Then the measurement configuration information of the L1 measurement corresponding to the candidate cell includes the reference measurement configuration information (the L1 measurement configuration information) and the differential measurement configuration information corresponding to the candidate cell.

In the differential configuration mode, the candidate cell configuration is configured in the LTM configuration. The candidate cell configuration includes differential measurement configuration information corresponding to each candidate cell, and the serving cell measurement configuration in the serving cell configuration is determined as reference measurement configuration information. Then the measurement configuration information of the L1 measurement corresponding to the candidate cell includes the reference measurement configuration information (the serving cell measurement configuration) and the differential measurement configuration information corresponding to the candidate cell in the candidate cell configuration.

In the differential configuration mode, the L1 measurement configuration information is configured in the LTM configuration. The L1 measurement configuration information includes differential measurement configuration information corresponding to each candidate cell, and the serving cell measurement configuration in the serving cell configuration is determined as reference measurement configuration information. Then the measurement configuration information of the L1 measurement corresponding to the candidate cell includes the reference measurement configuration information (the serving cell measurement configuration) and the differential measurement configuration information corresponding to the candidate cell in the L1 measurement configuration information.

Illustratively, the measurement window configuration in the candidate cell configuration is a configuration shared by all the candidate cells, and then the measurement window configuration of all the candidate cells for performing the L1 measurement includes the measurement window configuration of the serving cell and the measurement window configuration in the candidate cell configuration.

In some embodiments, the measurement window configuration in the candidate cell configuration is separately configured for each candidate cell, and then the measurement window configuration of the first candidate cell for performing the L1 measurement includes the measurement window configuration of the serving cell and the measurement window configuration corresponding to the first candidate cell in the candidate cell configuration.

Illustratively, the measurement window configuration in the candidate cell configuration is a configuration shared by all frequencies, and then the measurement window configuration of all the candidate cells for performing the L1 measurement includes the measurement window configuration of the serving cell and the measurement window configuration in the candidate cell configuration.

In some embodiments, the measurement window configuration in the candidate cell configuration is separately configured for each frequency, and then the measurement window configuration of the first candidate cell for performing the L1 measurement includes the measurement window configuration of the serving cell and the measurement window configuration of a first frequency corresponding to the first candidate cell in the candidate cell configuration.

For example, the measurement window configuration of the L1 measurement uses a joint configuration mode, at least one configuration information in the measurement window configuration of the serving cell is determined as a primary configuration, and the measurement window configuration in the candidate cell configuration is determined as a sub-configuration. The sub-configuration includes at least one configuration information, and the primary configuration and the sub-configuration include different pieces of configuration information. The measurement window configuration of the L1 measurement includes the primary configuration and the sub-configuration.

Mode 3) The LTM configuration further includes the L1 measurement configuration information of the candidate cell, and the measurement configuration information is determined based on the measurement configuration information, or the measurement window configuration is determined based on the L1 measurement configuration information.

That is, the RRC message includes the serving cell configuration and the LTM configuration. The LTM configuration includes the L1 measurement configuration information and the candidate cell configuration, and the L1 measurement configuration information includes a measurement window configuration of the L1 measurement.

Illustratively, the measurement window configuration in the L1 measurement configuration information includes at least one set of configuration information, and each set of configuration information corresponds to a candidate cell or a frequency.

In some embodiments, the measurement window configuration in the L1 measurement configuration information includes primary configuration information and sub-configuration information. Each sub-configuration information corresponds to a candidate cell or a frequency. The candidate cell/frequency measurement window configuration includes the sub-configuration information corresponding to the candidate cell/frequency and the primary configuration information. For example, the primary configuration information includes a measurement period and/or a measurement length of the measurement window, and the sub-configuration information includes a measurement offset of the measurement window and/or a downlink timing reference.

In some embodiments, the measurement window configuration in the L1 measurement configuration information is a set of configuration information, and all the candidate cells/frequencies share a set of configuration information.

Mode 4) The LTM configuration further includes the L1 measurement configuration information of the candidate cell, and the measurement configuration information is determined based on the serving cell measurement configuration and the L1 measurement configuration information, or the measurement window configuration is determined based on the serving cell measurement configuration and the L1 measurement configuration information.

Illustratively, the serving cell configuration is an initial serving cell configuration or a serving cell configuration of the currently accessed serving cell.

The L1 measurement configuration information of the candidate cell further includes the candidate cell measurement window configuration. The L1 measurement configuration information includes a group of measurement window configurations corresponding to each candidate cell/frequency. The L1 measurement configuration information includes a primary measurement window configuration and a measurement window sub-configuration. Each candidate cell/frequency corresponds to a group of measurement window configurations, and the measurement window configuration corresponding to the candidate cell/frequency includes the primary measurement window configuration and the measurement window sub-configuration corresponding to the candidate cell/frequency. The L1 measurement configuration information further includes a group of measurement window configurations shared by all the candidate cells/frequencies.

For example, the measurement window configuration of the L1 measurement uses the differential configuration mode. The measurement window configuration of the serving cell is determined as a reference configuration, the L1 measurement configuration information in the LTM configuration is determined as a differential configuration, and the measurement window configuration of the L1 measurement includes the measurement window configuration of the serving cell and the differential configuration corresponding to the candidate cell in the L1 measurement configuration information.

The measurement window configuration of the L1 measurement corresponding to the candidate cell/frequency includes the measurement window configuration of the serving cell and the differential measurement window configuration corresponding to the candidate cell/frequency in the L1 measurement configuration information.

Mode 5) The LTM configuration further includes the L1 measurement configuration information of the candidate cell, and the measurement configuration information is determined based on the candidate cell configuration and the L1 measurement configuration information, or the measurement window configuration is determined based on the candidate cell configuration and the L1 measurement configuration information.

The candidate cell measurement configuration information includes the L1 measurement window configuration of the candidate cell.

The L1 measurement configuration information includes the reference measurement window configuration corresponding to each candidate cell. The candidate cell configuration includes the differential measurement window configuration corresponding to each candidate cell. The candidate cell measurement window configuration includes the reference measurement window configuration corresponding to the candidate cell in the L1 measurement configuration information and the differential measurement window configuration corresponding to the candidate cell in the candidate cell configuration.

The L1 measurement configuration information further includes the reference measurement window configuration shared by all the candidate cells. The candidate cell configuration includes the differential measurement window configuration corresponding to each candidate cell. The candidate cell measurement window configuration includes the reference measurement window configuration and the differential measurement window configuration corresponding to the candidate cell in the candidate cell configuration.

The L1 measurement configuration information includes a primary measurement window configuration corresponding to each candidate cell. The candidate cell configuration includes a measurement window sub-configuration corresponding to each candidate cell. The candidate cell measurement window configuration includes the primary measurement window configuration corresponding to the candidate cell in the L1 measurement configuration information and the measurement window sub-configuration corresponding to the candidate cell in the candidate cell configuration.

The L1 measurement configuration information further includes a primary measurement window configuration shared by all the candidate cells. The candidate cell configuration includes a measurement window sub-configuration corresponding to each candidate cell. The candidate cell measurement window configuration includes the primary measurement window configuration and the measurement window sub-configuration corresponding to the candidate cell in the candidate cell configuration.

In S220, the first configuration information is maintained upon a cell switch.

Illustratively, the terminal monitors at least one candidate cell based on the measurement window configuration to acquire an L1 measurement result of the candidate cell/beam, and reports the L1 measurement result of the candidate cell/beam to the network device. The network device instructs, based on the L1 measurement result of the candidate cell/beam, the terminal to perform a cell switch, for example, to determine the first candidate cell as the target cell of a cell switch. Then the terminal switches the serving cell from the currently accessed first cell to the first candidate cell upon reviving a cell switch indication from the network device, and the switched first candidate cell is the serving cell of the terminal.

Upon the cell switch, the terminal maintains the first configuration information. Then the network device does not need to configure the first configuration information for the terminal upon the cell switch. Thus, in the ping-pong cell switch scenario, the terminal always monitors the candidate cell based on the first configuration information, such that the efficiency of candidate cell monitoring by the terminal is improved in the ping-pong cell switch scenario.

In some embodiments, upon a cell switch, the terminal continues to use the first configuration information.

In some embodiments, in a case where the first configuration information includes a set of measurement configuration information (measurement window configuration) shared by all the candidate cells, the terminal does not need to release the first configuration information upon a cell switch, and continues to use the first configuration information to perform the L1 measurement of the candidate cell.

In some embodiments, in a case where the first configuration information includes measurement configuration information (a measurement window configuration) corresponding to each candidate cell, the terminal does not need to release the first configuration information upon the cell switch, and continues to use the first configuration information to perform the L1 measurement of the candidate cell.

In some embodiments, upon a cell switch, the terminal updates the first configuration information.

In some embodiments, in a case where the first configuration information includes reference configuration information and differential configuration information, and each candidate cell/frequency corresponds to a set of differential configuration information. Upon a cell switch, the terminal updates the reference configuration information in the first configuration information based on the differential configuration information corresponding to the target cell (one of the candidate cells indicated by the network device) of the cell switch, such that new first configuration information is acquired. For example, the downlink timing in the reference configuration information is 3, the downlink timing in the differential configuration information corresponding to the target cell is 1, and then the new downlink timing acquired by updating the reference configuration information in the first configuration information based on the differential configuration information is 3+1=4.

The reference configuration information is a reference measurement window configuration, and the differential configuration information is a differential measurement window configuration.

In some embodiments, upon a cell switch, the terminal replaces the first configuration information with new first configuration information.

For example, each candidate cell corresponds to a set of first configuration information. Upon a cell switch, the terminal replaces the previous first configuration information based on the first configuration information corresponding to the target cell (one of the candidate cells indicated by the network device) of the cell switch, such that new first configuration information is acquired. For example, the terminal uses first configuration information A corresponding to the first cell (the current serving cell), and replaces first configuration information A with first configuration information B corresponding to the target cell upon switching from the first cell to the target cell by the cell switch.

In summary, in the method according to the embodiments, in the ping-pong LTM switch scenario, the terminal maintains the first configuration information upon a cell switch, and the network device does not need to reconfigure the measurement configuration information for the terminal upon each cell switch, such that the efficiency of candidate cell monitoring of the LTM by the terminal is improved.

In some embodiments, the first configuration information includes a candidate cell configuration of the LTM and measurement configuration information for monitoring the candidate cell. The measurement configuration information includes the measurement window configuration, and is configuration information shared by all the candidate cells.

The UE receives the candidate cell configuration of the LTM and the measurement configuration information for monitoring the candidate cell. The measurement configuration information for monitoring the candidate cell includes measurement information of all the candidate cells, for example, a reference signal resource for measurement, a reference signal period, or a reference signal start position, a measurement window configuration, a measurement report configuration, or the like. The measurement window configuration is at least one of an MG configuration, an SMTC, or an L1 measurement window configuration. In some embodiments, the SMTC is the measurement window configuration, and indicates a reused L3 SMTC or a new measurement window configuration for the L1 measurement.

The measurement configuration information is shared by all the candidate cells. That is, upon an LTM cell switch, the UE maintains the measurement configuration information. Illustratively, upon the cell switch, the terminal continues to use the measurement configuration information, updates the previous measurement configuration information based on the measurement configuration information associated with the switched serving cell, or replaces the previous measurement configuration information with the measurement configuration information associated with the switched serving cell.

Illustratively, the measurement window configuration in the measurement configuration information is configured for each candidate cell or each frequency, a group of measurement window configurations is configured for each candidate cell/frequency, or the primary measurement window configuration and the measurement window sub-configuration are configured for each candidate cell/frequency. That is, the measurement configuration information is configured in the following modes.
1) The measurement configuration information includes at least one measurement window configuration, and each measurement window configuration corresponds to a frequency. The measurement configuration information further includes first indication information, and the first indication information indicates the frequency corresponding to the measurement window configuration.
2) The measurement configuration information includes a primary measurement window configuration and at least one measurement window sub-configuration. Each measurement window sub-configuration corresponds to a frequency and includes a measurement offset and/or a downlink timing reference, and the primary measurement window configuration includes configuration parameters in the measurement window configuration other than the measurement window sub-configuration. The measurement configuration information further includes second indication information, and the second indication information indicates the frequency corresponding to the measurement window sub-configuration.
3) The measurement configuration information includes at least one measurement window configuration. Each measurement window configuration corresponds to a candidate cell. The measurement configuration information further includes third indication information, and the third indication information indicates the candidate cell corresponding to the measurement window configuration.
4) The measurement configuration information includes a primary measurement window configuration and at least one measurement window sub-configuration. Each measurement window sub-configuration corresponds to a candidate cell and includes a measurement offset and/or a downlink timing reference, and the primary measurement window configuration includes configuration parameters in the measurement window configuration other than the at least one measurement window sub-configuration. The measurement configuration information further includes fourth indication information, and the fourth indication information indicates the candidate cell corresponding to the measurement window sub-configuration.

For example, the measurement configuration information includes at least one SMTC (measurement window configuration).
1. Each SMTC is associated with a frequency, and the UE determines a SMTC for use based on the frequency of the current serving cell.
1.1 The SMTC being associated with the frequency means that the measurement configuration information includes a plurality of groups of SMTCs, and each SMTC corresponds to a frequency, and the plurality of SMTCs are in one-to-one correspondence with the frequencies.
1.2 The SMTC being associated with the frequency means that the measurement configuration information includes a group of primary SMTCs and a plurality of groups of sub-SMTCs. The sub-SMTC is associated with a frequency, and each group of sub-SMTCs includes frequency information (second indication information), and the offset (the measurement offset) and/or the downlink timing reference. Each frequency is associated with a measurement offset and/or a downlink timing reference. The UE uses the measurement offset and/or the downlink timing reference corresponding to the SMTC upon determining the SMTC. The parameters other than parameters carried in the sub-SMTC are provided by the primary SMTC. The sub-SMTC is contained in the candidate cell configuration and the measurement configuration information.
1.3 The SMTC being associated with the frequency means that the measurement configuration information includes at least one group of primary SMTCs and a plurality of groups of sub-SMTCs. Each group of primary SMTCs is associated with a candidate cell, and each group of sub-SMTCs is associated with a frequency. The terminal determines the primary SMTC based on the candidate cell for measurement, determines the sub-SMTC based on the frequency for measurement, and then acquires a complete SMTC (the primary SMTC and the sub-SMTC). Each group of sub-SMTCs includes frequency information, and the measurement offset and/or the downlink timing reference. Each frequency is associated with a measurement offset and/or a downlink timing reference. The UE uses the measurement offset and/or the downlink timing reference corresponding to the SMTC upon determining the SMTC. The parameters other than parameters carried in the sub-SMTC are provided by the primary SMTC.
2. Each SMTC is associated with a candidate cell.
2.1 The SMTC being associated with the candidate cell means that the measurement configuration information includes a plurality of groups of SMTCs, and each of the SMTCs corresponds to a candidate cell (a candidate cell identifier (ID) or a physical cell ID (PCI)), and the plurality of SMTCs are in one-to-one correspondence with the candidate cells.
2.2 The SMTC being associated with the candidate cell means that the measurement configuration information includes a group of primary SMTCs and a plurality of groups of sub-SMTCs. The sub-SMTC is associated with a candidate cell, and each group of sub-SMTCs includes candidate cell information (fourth indication information), and the offset (the measurement offset) and/or the downlink timing reference. Each candidate cell is associated with a measurement offset and/or a downlink timing reference. The UE uses the measurement offset and/or the downlink timing reference corresponding to the SMTC upon determining the SMTC. The parameters other than parameters carried in the sub-SMTC are provided by the primary SMTC.
2.3 The SMTC being associated with the candidate cell means that the measurement configuration information includes at least one group of primary SMTCs and a plurality of groups of sub-SMTCs. Each group of primary SMTCs is associated with a frequency, and each group of sub-SMTCs is associated with a candidate cell. The terminal determines the primary SMTC based on the frequency for measurement, determines the sub-SMTC based on the candidate cell for measurement, and then acquires a complete SMTC (the primary SMTC and the sub-SMTC). Each group of sub-SMTCs includes candidate cell information, and the measurement offset and/or the downlink timing reference. Each candidate cell is associated with a measurement offset and/or a downlink timing reference. The UE uses the measurement offset and/or the downlink timing reference corresponding to the SMTC upon determining the SMTC. The parameters other than parameters carried in the sub-SMTC are provided by the primary SMTC.

For the UE, the UE receives the measurement configuration information, stores the measurement configuration information in a corresponding UE variable, and performs the corresponding L1 measurement and report based on the configuration. In a case where the UE determines the target cell for switch (the terminal determines the target cell based on the cell switch condition, or the terminal receives the indication from the network device), the UE performs the cell switch process based on the target cell configuration. In the process, the UE continues to maintain (does not release) the content in the variables associated with the measurement configuration information, such that the UE continues to monitor and evaluate the LTM candidate cell in the new cell (the target cell).

The UE determines the target SMTC based on a switch type and/or an SMTC type. The switch type includes inter-frequency switch and intra-frequency switch. The SMTC type includes a configuration of the SMTC for the candidate cell, a configuration of the SMTC for the frequency, a configuration of the SMTC for each candidate cell/frequency, a configuration of the sub-SMTC for each candidate cell/frequency, and the like. For example, in a case where the UE performs inter-frequency switch, the UE updates the corresponding measurement offset and/or downlink timing reference based on the (sub-)SMTC associated with the frequency of the target cell. In a case where the SMTC is associated with the target cell (the to-cell that is to switched to and is selected from the candidate cells), the UE updates the corresponding measurement offset and/or downlink timing reference based on the SMTC associated with the target cell.

In some embodiments, in a case where the candidate cell configuration includes a candidate cell group configuration, that is, an sPCell and at least one SCell, the candidate cell and/or the target cell correspond to the sPCell in the candidate cell group. For example, upon the LTM switch, the frequency of the target cell corresponds to the frequency of the sPCell. For example, the SMTC is applicable to the sPCell upon the LTM.

For example, the measurement configuration information further includes at least one MG configuration. Each of the at least one MG configuration includes at least one of a period of MG, a MG measurement offset, a gap duration, or a downlink timing reference.

Similar to the SMTC, the MG configuration is associated with the frequency or the candidate cell as follows.
3. Each of the at least one MG configuration is associated with a frequency, and the UE determines the MG for use based on the frequency of the current serving cell.
3.1 The MG configuration being associated with the frequency means that the measurement configuration information includes a plurality of groups of MG configurations, and each of the MG configurations corresponds to a frequency, and the plurality of MG configurations are in one-to-one correspondence with the frequencies.
3.2 The MG configuration being associated with the frequency means that the measurement configuration information includes a group of primary MG configurations and a plurality of groups of MG sub-configurations. The MG sub-configuration is associated with a frequency, and each group of MG sub-configurations includes frequency information (second indication information), and the gap measurement offset and/or the downlink timing reference. Each frequency is associated with a gap measurement offset and/or a downlink timing reference. The UE uses the measurement offset and/or the downlink timing reference corresponding to the MG configuration upon determining the MG configuration. The parameters other than parameters carried in the MG sub-configuration are provided by the primary MG configuration. The MG sub-configuration is contained in the candidate cell configuration and the measurement configuration information.
3.3 The MG configuration being associated with the frequency means that the measurement configuration information includes at least one group of primary MG configurations and a plurality of groups of MG sub-configurations. Each group of primary MG configurations is associated with a candidate cell, and each group of MG sub-configurations is associated with a frequency. The terminal determines the primary MG configuration based on the candidate cell for measurement, determines the MG sub-configuration based on the frequency for measurement, and then acquires a complete MG configuration (the primary MG configuration and the MG sub-configuration). Each group of MG sub-configurations includes frequency information, and the gap offset (the gap measurement offset) and/or the downlink timing reference. Each frequency is associated with a gap offset and/or a downlink timing reference. The UE uses the gap offset and/or the downlink timing reference corresponding to the MG configuration upon determining the MG configuration. The parameters other than parameters carried in the MG sub-configuration are provided by the primary MG configuration.
4. Each MG configuration is associated with a candidate cell.
4.1 The MG configuration being associated with the candidate cell means that the measurement configuration information includes a plurality of groups of MG configurations, and each of the MG configurations corresponds to a candidate cell (a candidate cell ID or PCI), and the plurality of MG configurations are in one-to-one correspondence with the candidate cells.
4.2 The MG configuration being associated with the candidate cell means that the measurement configuration information includes a group of primary MG configurations and a plurality of groups of MG sub-configurations. The MG sub-configuration is associated with a candidate cell, and each group of MG sub-configurations includes candidate cell information, and the gap offset (the gap measurement offset) and/or the downlink timing reference. Each candidate cell is associated with a gap offset and/or a downlink timing reference. The UE uses the gap offset and/or the downlink timing reference corresponding to the MG configuration upon determining the MG configuration. The parameters other than parameters carried in the MG sub-configuration are provided by the primary MG configuration.
4.3 The MG configuration being associated with the candidate cell means that the measurement configuration information includes at least one group of primary MG configurations and a plurality of groups of MG sub-configurations. Each group of primary MG configurations is associated with a frequency, and each group of MG sub-configurations is associated with a candidate cell. The terminal determines the primary MG configuration based on the frequency for measurement, determines the MG sub-configuration based on the candidate cell for measurement, and then acquires complete MG configuration (the primary MG configuration and the MG sub-configuration). Each group of MG sub-configurations includes candidate cell information (fourth indication information), and the gap offset (the gap measurement offset) and/or the downlink timing reference. Each candidate cell is associated with a gap offset and/or a downlink timing reference. The UE uses the measurement offset and/or the downlink timing reference corresponding to the MG configuration upon determining the MG configuration. The parameters other than parameters carried in the MG sub-configuration are provided by the primary MG configuration.

In some embodiments, in a case where the SMTC or MG configuration is associated with the frequency, the measurement configuration information further carries indication information. The indication information indicates the frequency associated with the SMTC and/or MG configuration. The indication information indicates the frequency in an implicit mode. For example, each SMTC and/or MG configuration is associated with at least one candidate cell (group), and the UE determines the corresponding frequency based on the candidate cell (group) identifier and determines the SMTC for use and the MG configuration based on the frequency.

For example, an SMTC list is configured for each frequency, and each candidate cell is associated with an SMTC ID. In a case where the UE accesses the candidate cell, the UE updates the measurement configuration information for each frequency based on the SMTC corresponding to the SMTC ID. For example, the SMTC list of FR 1 includes SMTC ID 1, SMTC ID 2, and SMTC ID 3, and the SMTC list of FR 2 includes SMTC ID 1, SMTC ID 2, and SMTC ID 3. In a case where the SMTC IDs corresponding to the candidate cell are FR1: SMTC ID=2 and FR2: SMTC ID=1, the measurement configuration information for each frequency is updated based on the SMTC corresponding to SMTC ID=2 on the FR 1 frequency and based on the SMTC corresponding to SMTC ID=1 on the FR 2 frequency.

In some embodiments, the SMTC for each frequency forms different combinations, and each combination corresponds to an ID. Then, the candidate cell is associated with the ID of the combination. For example, the SMTC list includes combination ID 1, combination ID 2, and combination ID3. Combination ID1 corresponds to FR 1 SMT 1+FR 2 SMT 1, combination ID 2 corresponds to FR1 SMT 2+FR 2 SMT 1, and combination ID3 corresponds to FR 1 SMT 2+FR 2 SMT3. In a case where the candidate cell corresponds to combination ID1, the measurement configuration information for each frequency is updated based on SMTC 1 on the FR 1 frequency and based on SMTC 1 on the FR 2 frequency.

In some embodiments, the measurement configuration information includes a plurality of groups of SMTCs and the candidate cell ID and/or PCI applicable to each group of SMTCs. Each group of SMTCs includes SMTC for a plurality of frequencies.

| | |
|---|---|
| SSB-MTC-LTM-r18 ::= | SEQUENCE { |
| pci-List-r18 | SEQUENCE (SIZE |
| | (1..maxNrofPCIsPerSMTC)) OF PhysCellId |

OPTIONAL, -- Need M

| | |
|---|---|
| offset-r17 | INTEGER (0..159) |

In some embodiments, the first configuration information is a cell-level measurement configuration separately configured for each candidate cell/frequency. The first configuration information includes the candidate cell configuration of the LTM, the candidate cell configuration includes the candidate cell measurement configuration information, and the measurement configuration information includes the measurement window configuration. Alternatively, the candidate cell configuration includes the candidate cell measurement configuration information.

The UE receives the LTM candidate cell configuration and the measurement configuration information for monitoring the candidate cell. The measurement configuration information for monitoring the candidate cell includes the measurement information of all the candidate cells, for example, the reference signal resource for measurement, the reference signal period, the reference signal start position, the measurement window configuration, the measurement report configuration, and the like. The measurement window configuration includes at least one of the MG configuration, the SMTC, or the L1 measurement window configuration. The SMTC refers to the measurement window configuration, and indicates a reused L3 SMTC or a new measurement window configuration for the L1 measurement.

The measurement configuration information is part of the serving cell configuration. Upon an LTM cell switch, the UE determines/updates the measurement configuration information based on the measurement configuration information of the target cell for subsequent LTM candidate cell monitoring.

For example, the terminal uses the first configuration information of the first cell (the current server cell). In a case where the terminal switches the server cell from the first cell to the second cell (one of the candidate cells), the terminal replaces the measurement configuration information from the first measurement configuration information corresponding to the first cell with the second measurement configuration information corresponding to the second cell. The candidate cell configuration of the second cell includes the second measurement configuration information.

Upon receiving the measurement configuration information, the UE stores the measurement configuration information in the corresponding variable. In a case where the UE performs the cell switch, the UE reads the measurement configuration information corresponding to the target cell from the variable and uses the measurement configuration information associated with the new serving cell (the target cell).

It should be noted that the processes in the embodiments may be combined arbitrarily to form new embodiments, which are not limited in the present disclosure.

FIG. 21 is a block diagram of an apparatus for configuring a measurement window according to some embodiments of the present disclosure. The apparatus is practiced as a terminal or part of a terminal, and includes:
a receiving module 401, configured to receive first configuration information, wherein the first configuration information is used to determine a measurement window configuration, wherein the measurement window configuration is used to monitor LTM candidate cells.

In some embodiments, the measurement window configuration includes at least one of a first-type configuration, a second-type configuration, or a third-type configuration, wherein the first-type configuration is used to configure an MG, wherein the terminal suspends data communication with a serving cell within the MG; the second-type configuration includes SMTC; and the third-type configuration is used to configure the measurement window for an L1 measurement.

In some embodiments, any one of the first-type configuration, the second-type configuration, or the third-type configuration includes at least one of a measurement period of the measurement window, a measurement offset of the measurement window, a measurement length of the measurement window, or a downlink timing reference.

In some embodiments, the measurement window configuration is used to perform at least one of an L1 measurement or an L3 measurement.

In some embodiments, the measurement window configuration is used to monitor at least one of a serving cell, a neighbor cell, or a candidate cell.

In some embodiments, the first configuration information further includes at least one of a reference signal configuration for measurement, a measurement object configuration, or a measurement report configuration.

In some embodiments, the first configuration information includes at least one of a set of configuration information corresponding to each candidate cell, a set of configuration information corresponding to each candidate cell group, a set of configuration information shared by all the candidate cells, a set of configuration information corresponding to each frequency, or a set of configuration information corresponding to each BWP, wherein the set of configuration information includes at least one of the measurement window configuration, the reference signal configuration for measurement, the measurement object configuration, or the measurement report configuration.

In some embodiments, the first configuration information is determined based on at least one of a serving cell measurement configuration, a candidate cell reference configuration, a combination of a candidate cell reference configuration and a candidate cell differential configuration, or an LTM configuration.

In some embodiments, the apparatus further includes a storing module 402, configured to: continue to use the first configuration information upon a cell switch; update the first configuration information upon the cell switch; or replace the first configuration information with new first configuration information upon the cell switch.

In some embodiments, the first configuration information includes an LTM candidate cell configuration and measurement configuration information for monitoring a candidate cell, wherein the measurement configuration information includes the measurement window configuration, and is configuration information shared by all the candidate cells.

In some embodiments, the apparatus further includes a storing module 402, configured to maintain the measurement configuration information upon a cell switch.

In some embodiments, the measurement configuration information includes at least one measurement window configuration, wherein each of the at least one measurement window configuration corresponds to a frequency.

In some embodiments, the measurement configuration information further includes first indication information, wherein the first indication information indicates the frequency corresponding to the each of the at least one measurement window configuration.

In some embodiments, the measurement configuration information includes a primary measurement window configuration and at least one measurement window sub-configuration, wherein each of the at least one measurement window sub-configuration corresponds to a frequency and includes a measurement offset and/or a downlink timing reference, and the primary measurement window configuration includes configuration parameters in the measurement window configuration other than the at least one measurement window sub-configuration.

In some embodiments, the measurement configuration information further includes second indication information, wherein the second indication information indicates the frequency corresponding to the each of the at least one measurement window sub-configuration.

In some embodiments, the measurement configuration information includes at least one measurement window configuration, wherein each of the at least one measurement window configuration corresponds to a candidate cell.

In some embodiments, the measurement configuration information further includes third indication information, wherein the third indication information indicates the candidate cell corresponding to the each of the at least one measurement window configuration.

In some embodiments, the measurement configuration information includes a primary measurement window configuration and at least one measurement window sub-configuration, wherein each of the at least one measurement window sub-configuration corresponds to a candidate cell and includes a measurement offset and/or a downlink timing reference, and the primary measurement window configuration includes configuration parameters in the measurement window configuration other than the at least one measurement window sub-configuration.

In some embodiments, the measurement configuration information further includes fourth indication information, wherein the fourth indication information indicates the candidate cell corresponding to the each of the at least one measurement window sub-configuration.

In some embodiments, the first configuration information includes an LTM candidate cell configuration, wherein the candidate cell configuration includes measurement configuration information of a candidate cell, wherein the measurement configuration information includes the measurement window configuration.

In some embodiments, the apparatus further includes a storing module 402, configured to: update the measurement configuration information based on measurement configuration information associated with a switched serving cell upon a cell switch; or replace the measurement configuration information with measurement configuration information associated with a switched serving cell upon a cell switch.

In some embodiments, the measurement configuration information further includes at least one of a reference signal configuration for measurement, a measurement object configuration, or a measurement report configuration.

In some embodiments, the receiving module is configured to: receive an RRC message, wherein the RRC message carries a serving cell configuration and an LTM configuration, wherein the LTM configuration includes the candidate cell configuration; wherein the measurement configuration information is determined based on a serving cell measurement configuration in a serving cell configuration; the measurement configuration information is determined based on a serving cell measurement configuration and the candidate cell configuration; the LTM configuration further includes L1 measurement configuration information, wherein the measurement configuration information is determined based on the L1 measurement configuration information; the LTM configuration further includes L1 measurement configuration information, wherein the measurement configuration information is determined based on a serving cell measurement configuration and the L1 measurement configuration information; or the LTM configuration further includes L1 measurement configuration information, wherein the measurement configuration information is determined based on the candidate cell configuration and the L1 measurement configuration information.

FIG. 22 is a block diagram of an apparatus for configuring a measurement window according to some embodiments of the present disclosure. The apparatus is practiced as a network device or part of a network device, and includes:
a transmitting module 403, configured to transmit first configuration information, wherein the first configuration information is used to determine a measurement window configuration, wherein the measurement window configuration is used to monitor LTM candidate cells.

In some embodiments, the measurement window configuration includes at least one of a first-type configuration, a second-type configuration, or a third-type configuration, wherein the first-type configuration is used to define an MG, wherein a terminal suspends data communication with a serving cell within the MG; the second-type configuration includes SMTC; and the third-type configuration is used to define the measurement window for an L1 measurement.

In some embodiments, any one of the first-type configuration, the second-type configuration, or the third-type configuration includes at least one of a measurement period of the measurement window, a measurement offset of the measurement window, a measurement length of the measurement window, or a downlink timing reference.

In some embodiments, the measurement window configuration is used to perform at least one of an L1 measurement or an L3 measurement.

In some embodiments, the measurement window configuration is used to monitor at least one of a serving cell, a neighbor cell, or a candidate cell.

In some embodiments, the first configuration information further includes at least one of a reference signal configuration for measurement, a measurement object configuration, or a measurement report configuration.

In some embodiments, the first configuration information includes at least one of a set of configuration information corresponding to each candidate cell, a set of configuration information corresponding to each candidate cell group, a set of configuration information shared by all the candidate cells, a set of configuration information corresponding to each frequency, or a set of configuration information corresponding to each BWP, wherein the set of configuration information includes at least one of the measurement window configuration, the reference signal configuration for measurement, the measurement object configuration, or the measurement report configuration.

In some embodiments, the first configuration information is determined based on at least one of a serving cell measurement configuration, a candidate cell reference configuration, a combination of a candidate cell reference configuration and a candidate cell differential configuration, or an LTM configuration.

In some embodiments, the first configuration information is maintained upon a cell switch by a terminal, the first configuration information is updated upon a cell switch by a terminal, or the first configuration information is replaced with new first configuration information upon a cell switch by a terminal.

In some embodiments, the first configuration information includes an LTM candidate cell configuration and measurement configuration information for monitoring a candidate cell, wherein the measurement configuration information includes the measurement window configuration, and is configuration information shared by all the candidate cells.

In some embodiments, the measurement configuration information is maintained upon a cell switch by a terminal.

In some embodiments, the measurement configuration information includes at least one measurement window configuration, wherein each of the at least one measurement window configuration corresponds to a frequency.

In some embodiments, the measurement configuration information further includes first indication information, wherein the first indication information indicates the frequency corresponding to the each of the at least one measurement window configuration.

In some embodiments, the measurement configuration information includes a primary measurement window configuration and at least one measurement window sub-configuration, wherein each of the at least one measurement window sub-configuration corresponds to a frequency and includes a measurement offset and/or a downlink timing reference, and the primary measurement window configuration includes configuration parameters in the measurement window configuration other than the at least one measurement window sub-configuration.

In some embodiments, the measurement configuration information further includes second indication information, wherein the second indication information indicates the frequency corresponding to the each of the at least one measurement window sub-configuration.

In some embodiments, the measurement configuration information includes at least one measurement window configuration, wherein each of the at least one measurement window configuration corresponds to a candidate cell.

In some embodiments, the measurement configuration information further includes third indication information, wherein the third indication information indicates the candidate cell corresponding to the each of the at least one measurement window configuration.

In some embodiments, the measurement configuration information includes a primary measurement window configuration and at least one measurement window sub-configuration, wherein each of the at least one measurement window sub-configuration corresponds to a candidate cell and includes a measurement offset and/or a downlink timing reference, and the primary measurement window configuration includes configuration parameters in the measurement window configuration other than the at least one measurement window sub-configuration.

In some embodiments, the measurement configuration information further includes fourth indication information, wherein the fourth indication information indicates the candidate cell corresponding to the each of the at least one measurement window sub-configuration.

In some embodiments, the first configuration information includes an LTM candidate cell configuration, wherein the candidate cell configuration includes measurement configuration information of a candidate cell, wherein the measurement configuration information includes the measurement window configuration.

In some embodiments, the measurement configuration information is updated based on measurement configuration information associated with a switched serving cell upon a cell switch by a terminal, or the measurement configuration information is replaced with measurement configuration information associated with a switched serving cell upon a cell switch by a terminal.

In some embodiments, the measurement configuration information further includes at least one of a reference signal configuration for measurement, a measurement object configuration, or a measurement report configuration.

In some embodiments, the transmitting module 403 is configured to transmit an RRC message, wherein the RRC message carries a serving cell configuration and an LTM configuration, wherein the LTM configuration includes the candidate cell configuration; wherein the measurement configuration information is determined based on a serving cell measurement configuration in the serving cell configuration; the measurement configuration information is determined based on the serving cell measurement configuration and the candidate cell configuration; the LTM configuration further includes L1 measurement configuration information, wherein the measurement configuration information is determined based on the L1 measurement configuration information; the LTM configuration further includes L1 measurement configuration information, wherein the measurement configuration information is determined based on the serving cell measurement configuration and the L1 measurement configuration information; or the LTM configuration further includes L1 measurement configuration information, wherein the measurement configuration information is determined based on the candidate cell configuration and the L1 measurement configuration information.

FIG. 23 is a schematic structural diagram of a communication device (a terminal or a network device) according to some embodiments of the present disclosure. The communication device includes: a processor 101, a receiver 102, a transmitter 103, a memory 104, and a bus 105.

The processor 101 includes one or more processing cores, and achieves various functional applications and information processing by running software programs and modules.

The receiver 102 and the transmitter 103 are practiced as a communication assembly. The communication assembly is a communication chip, and is also referred to as a transceiver.

The memory 104 is connected to the processor 101 via the bus 105.

The memory 104 is configured to store one or more instructions, and the processor 101 is configured to load and execute the one or more instructions to perform various processes in the above method embodiments.

In addition, the memory 104 is practiced by any type of volatile or non-volatile storage device or combinations thereof. The volatile or non-volatile storage device includes, but is not limited to, a disk or optical disc, an electrically erasable programmable read-only memory (EEPROM), an erasable programmable read-only memory (EPROM), a persistent random-access memory (SRAM), a read-only memory (ROM), a magnetic memory, a flash memory, or a programmable read-only memory (PROM).

In a case where the communication device is practiced as a terminal, the processor and the transceiver in the communication device in the embodiments of the present disclosure are configured to perform the processes performed by the terminal in any of above methods, which is not repeated any further.

In some embodiments, in a case where the communication device is practiced as a terminal, the transceiver is configured to receive first configuration information, wherein the first configuration information is used to determine a measurement window configuration, wherein the measurement window configuration is used to monitor LTM candidate cells.

In some embodiments, in a case where the communication device is practiced as a network device, the transceiver is configured to transmit first configuration information, wherein the first configuration information is used to determine a measurement window configuration, wherein the measurement window configuration is used to monitor LTM candidate cells.

Some embodiments of the present disclosure further provide a computer-readable storage medium storing one or more instructions, one or more programs, a code set, or an instruction set, wherein the one or more instructions, the one or more programs, the code set, or the instruction set, when loaded and run by a processor, cause the processor to perform the method for configuring the measurement window in the above method embodiments.

Some embodiments of the present disclosure further provide a chip. The chip includes programmable logic circuitry and/or program instructions, and when running on a communication device, causes the communication device to perform the method for configuring the measurement window in the above method embodiments.

Some embodiments of the present disclosure further provide a computer program product. The computer program product, when running on a processor of a communication device, causes the communication device to perform the method for configuring the measurement window in the above method embodiments.

It should be understood by those skilled in the art that all or part of processes in the embodiments are practiced by the hardware, or related hardware instructed by the programs. The programs are stored in a computer-readable storage medium. The storage medium is a ROM, a disk, an optical disc, or the like.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for configuring a measurement window, performed by a terminal, the method comprising:
receiving first configuration information, wherein the first configuration information is used to determine a measurement window configuration, wherein the measurement window configuration is used to monitor Layer 1 or Layer 2 triggered mobility (LTM) candidate cells.

2. The method according to claim 1, wherein the measurement window configuration comprises at least one of a first-type configuration, a second-type configuration, or a third-type configuration; wherein the first-type configuration is used to configure a measurement gap (MG), wherein the terminal suspends data communication with a serving cell within the MG; the second-type configuration comprises a synchronization signal/physical broadcast channel block measurement timing configuration (SMTC); and the third-type configuration is used to configure the measurement window for a Layer 1 measurement.

3. The method according to claim 2, wherein
any one of the first-type configuration, the second-type configuration, or the third-type configuration comprises at least one of a measurement period of the measurement window, a measurement offset of the measurement window, a measurement length of the measurement window, or a downlink timing reference;
the measurement window configuration is used to perform at least one of a Layer 1 measurement or a Layer 3 measurement, and is used to monitor at least one of a serving cell, a neighbor cell, or a candidate cell; and
the first configuration information further comprises at least one of a reference signal configuration for measurement, a measurement object configuration, or a measurement report configuration.

4. The method according to claim 3, wherein the first configuration information comprises at least one of: a set of configuration information corresponding to each candidate cell; a set of configuration information corresponding to each candidate cell group; a set of configuration information shared by all the candidate cells; a set of configuration information corresponding to each frequency; or a set of configuration information corresponding to each bandwidth part (BWP); wherein the set of configuration information comprises at least one of the measurement window configuration, the reference signal configuration for measurement, the measurement object configuration, or the measurement report configuration.

5. The method according to claim 1, wherein the first configuration information is determined based on at least one of: a serving cell measurement configuration; a candidate cell reference configuration; a combination of a candidate cell reference configuration and a candidate cell differential configuration; or an LTM configuration.

6. The method according to claim 1, further comprising:
continuing to use the first configuration information upon a cell switch;
updating the first configuration information upon a cell switch; or
replacing the first configuration information with new first configuration information upon a cell switch.

7. The method according to claim 1, wherein the first configuration information comprises an LTM candidate cell configuration, wherein the candidate cell configuration comprises measurement configuration information of a candidate cell, wherein the measurement configuration information comprises the measurement window configuration.

8. The method according to claim 1, further comprising:
updating the measurement configuration information based on measurement configuration information associated with a switched serving cell upon a cell switch; or
replacing the measurement configuration information with measurement configuration information associated with a switched serving cell upon a cell switch.

9. A terminal, comprising: a processor and a memory storing one or more instructions, one or more programs, a code set, or an instruction set; wherein the processor is configured to load and run the one or more instructions, the one or more programs, the code set, or the instruction set to cause the terminal to:
receive first configuration information, wherein the first configuration information is used to determine a measurement window configuration, wherein the measurement window configuration is used to monitor Layer 1 or Layer 2 triggered mobility (LTM) candidate cells.

10. The terminal according to claim 9, wherein the first configuration information comprises an LTM candidate cell configuration and measurement configuration information for monitoring a candidate cell, wherein the measurement configuration information comprises the measurement window configuration, and is configuration information shared by all the candidate cells, and the processor is configured to load and run the one or more instructions, one or more programs, a code set, or an instruction set to cause the terminal to:
maintain the measurement configuration information upon a cell switch, wherein the measurement configuration information comprises at least one measurement window configuration, wherein each of the at least one measurement window configuration corresponds to a frequency.

11. The terminal according to claim 10, wherein the measurement configuration information further comprises first indication information, wherein the first indication information indicates the frequency corresponding to the each of the at least one measurement window configuration.

12. The terminal according to claim 10, wherein
the measurement configuration information comprises a primary measurement window configuration and at least one measurement window sub-configuration, wherein each of the at least one measurement window sub-configuration corresponds to a frequency and comprises a measurement offset and/or a downlink timing reference, and the primary measurement window configuration comprises configuration parameters in the measurement window configuration other than the at least one measurement window sub-configuration; or
the measurement configuration information comprises at least one measurement window configuration, wherein each of the at least one measurement window configuration corresponds to a candidate cell.

13. The terminal according to claim 12, wherein the measurement configuration information further comprises second indication information, wherein the second indication information indicates the frequency corresponding to the each of the at least one measurement window sub-configuration.

14. The terminal according to claim 10, wherein the measurement configuration information further comprises third indication information, wherein the third indication information indicates the candidate cell corresponding to the each of the at least one measurement window configuration.

15. The terminal according to claim 10, wherein the measurement configuration information comprises a primary measurement window configuration and at least one measurement window sub-configuration, wherein each of the at least one measurement window sub-configuration corresponds to a candidate cell and comprises a measurement offset and/or a downlink timing reference, and the primary measurement window configuration comprises configuration parameters in the measurement window configuration other than the at least one measurement window sub-configuration.

16. The terminal according to claim 15, wherein the measurement configuration information further comprises fourth indication information, wherein the fourth indication information indicates the candidate cell corresponding to the each of the at least one measurement window sub-configuration.

17. The terminal according to claim 10, wherein the measurement configuration information further comprises at least one of a reference signal configuration for measurement, a measurement object configuration, or a measurement report configuration.

18. The terminal according to claim 10, wherein the processor is configured to load and run the one or more instructions, the one or more programs, the code set, or the instruction set to cause the terminal to:
receive a radio resource control (RRC) message, wherein the RRC message carries a serving cell configuration and an LTM configuration, wherein the LTM configuration comprises the candidate cell configuration; wherein
the measurement configuration information is determined based on a serving cell measurement configuration in the serving cell configuration;
the measurement configuration information is determined based on a serving cell measurement configuration and the candidate cell configuration;
the LTM configuration further comprises Layer 1 measurement configuration information, wherein the measurement configuration information is determined based on the Layer 1 measurement configuration information;
the LTM configuration further comprises Layer 1 measurement configuration information, wherein the measurement configuration information is determined based on a serving cell measurement configuration and the Layer 1 measurement configuration information; or
the LTM configuration further comprises Layer 1 measurement configuration information, wherein the measurement configuration information is determined based on the candidate cell configuration and the Layer 1 measurement configuration information.

19. A network device, comprising: a processor and a memory storing one or more instructions, one or more programs, a code set, or an instruction set; wherein the processor is configured to load and run the one or more instructions, the one or more programs, the code set, or the instruction set to cause the network device to:
transmit first configuration information, wherein the first configuration information is used to determine a measurement window configuration, wherein the measurement window configuration is used to monitor candidate cells for Layer 1 or Layer 2 triggered mobility (LTM).

20. The network device according to claim 19, wherein the measurement window configuration comprises at least one of a first-type configuration, a second-type configuration, or a third-type configuration, wherein the first-type configuration is used to configure a measurement gap (MG), wherein a terminal suspends data communication with a serving cell within the MG; the second-type configuration comprises a synchronization signal/physical broadcast channel block measurement timing configuration (SMTC); and the third-type configuration is used to configure the measurement window for a Layer 1 measurement.
